(19) United States
(12) Patent Application Publication
(10) Pub. No.: US 2026/0100746 A1
(43) Pub. Date: Apr. 9, 2026

(54) BEAM SELECTION FOR SMALL DATA TRANSMISSION

(71) Applicant: QUALCOMM Incorporated, San Diego, CA (US)

(72) Inventors: Nazmul ISLAM, Littleton, MA (US); Navid ABEDINI, Basking Ridge, NJ (US)

(21) Appl. No.: 18/909,857

(22) Filed: Oct. 8, 2024

(51) Int. Cl. H04B 7/06

(52) U.S. Cl. CPC H04B 7/06952; H04B 7/0626

(57) ABSTRACT

Various aspects of the present disclosure generally relate to wireless communication. In some aspects, a user equipment (UE) may receive, from a network node, priority information associated with a first communication beam and a second communication beam. The UE may initiate, with the network node using at least one of the first communication beam or the second communication beam, a small data transmission operation in association with selecting a communication beam according to the priority information. Numerous other aspects are described.

### FIELD OF THE DISCLOSURE

Aspects of the present disclosure generally relate to wireless communication and specifically relate to techniques, apparatuses, and methods associated with beam selection for small data transmission.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some aspects, an apparatus for wireless communication at a user equipment (UE) includes one or more memories; and one or more processors, coupled to the one or more memories, individually or collectively configured to cause the UE to: receive, from a network node, priority information associated with a first communication beam and a second communication beam; and initiate, with the network node using at least one of the first communication beam or the second communication beam, a small data transmission operation in association with selecting a communication beam according to the priority information.

In some aspects, an apparatus for wireless communication at a network node includes one or more memories; and one or more processors, coupled to the one or more memories, individually or collectively configured to cause the network node to: transmit, to a UE, priority information associated with a first communication beam and a second communication beam; and perform, via a communication beam that is selected by the UE, a small data transmission operation according to the priority information, wherein the communication beam includes at least one of the first communication beam or the second communication beam.

In some aspects, a method of wireless communication performed by a UE includes receiving, from a network node, priority information associated with a first communication beam and a second communication beam; and initiating, with the network node via at least one of the first communication beam or the second communication beam, a small data transmission operation in association with selecting a communication beam according to the priority information.

In some aspects, a method of wireless communication performed by a network node includes transmitting, to a UE, priority information associated with a first communication beam and a second communication beam; and performing, via a communication beam that is selected by the UE, a small data transmission operation according to the priority information, wherein the communication beam includes at least one of the first communication beam or the second communication beam.

In some aspects, a non-transitory computer-readable medium storing a set of instructions for wireless communication includes one or more instructions that, when executed by one or more processors of a UE, cause the UE to: receive, from a network node, priority information associated with a first communication beam and a second communication beam; and initiate, with the network node using at least one of the first communication beam or the second communication beam, a small data transmission operation in association with selecting a communication beam according to the priority information.

In some aspects, a non-transitory computer-readable medium storing a set of instructions for wireless communication includes one or more instructions that, when executed by one or more processors of a network node, cause the network node to: transmit, to a UE, priority information associated with a first communication beam and a second communication beam; and perform, via a communication beam that is selected by the UE, a small data transmission operation according to the priority information, wherein the communication beam includes at least one of the first communication beam or the second communication beam.

In some aspects, an apparatus for wireless communication includes means for receiving, from a network node, priority information associated with a first communication beam and a second communication beam; and means for initiating, with the network node using at least one of the first communication beam or the second communication beam, a small data transmission operation in association with selecting a communication beam according to the priority information.

In some aspects, an apparatus for wireless communication includes means for transmitting, to a UE, priority information associated with a first communication beam and a second communication beam; and means for performing, via a communication beam that is selected by the UE, a small data transmission operation according to the priority information, wherein the communication beam includes at least one of the first communication beam or the second communication beam.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating examples of reference signal beam management procedures, in accordance with the present disclosure.

FIG. 4 is a diagram illustrating an example of a hybrid beamforming codebook, in accordance with the present disclosure.

FIG. 5 is a diagram illustrating an example including aspects of a two-step random access procedure and a four-step random access procedure that supports small data transmission (SDT), in accordance with the present disclosure.

FIG. 6 is a diagram illustrating an example of uplink configured grant communication that supports SDT, in accordance with the present disclosure, in accordance with the present disclosure.

FIG. 7 is a diagram of an example associated with priority-based beam selection for SDT, in accordance with the present disclosure.

FIG. 8 is a diagram illustrating an example of a wireless communications system that supports network energy saving for SDT, in accordance with the present disclosure.

FIG. 9 is a diagram illustrating an example process performed, for example, at a user equipment or an apparatus of a user equipment, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Network energy saving (NES) and/or network energy efficiency measures are expected to have increased importance in wireless network operations for various reasons, such as climate change mitigation, environmental sustainability, and/or network cost reduction, among other examples. For example, although 5G New Radio (NR) generally offers a significant energy efficiency improvement per gigabyte over previous generations (for example, long term evolution (LTE)), new NR use cases and/or the adoption of millimeter wave frequencies may require more network sites, more network antennas, larger bandwidths, and/or more frequency bands, among other examples, which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth of the total cost to operate a wireless network, and over 90% of network operating costs are spent on energy (for example, fuel and electricity). The largest proportion of energy consumption and/or energy costs are associated with a radio access network (RAN), which accounts for about half of the energy consumption in a wireless network, with data centers and fiber transport accounting for smaller shares. Accordingly, measures to increase network energy savings and/or improve network energy efficiency are factors that may drive adoption and/or expansion of wireless networks.

In some examples, a user equipment (UE) or network node may implement power saving features (also referred to as energy saving features). Power saving features may include, for example, relaxed radio resource monitoring (such as relaxed reference signal monitoring for devices operating in low mobility or in good radio conditions), discontinuous reception (DRX) operation, reduced physical downlink control channel (PDCCH) monitoring during DRX active times, on-demand system information transmission, on-demand synchronization signal block (SSB) transmission, antenna port adaptation, advanced channel state information (CSI) reporting, and/or power-efficient paging reception.

A UE and/or a network node may perform beam selection as part of an initial access and/or a handover procedure. For example, beam selection may include the network node performing beam sweeping over multiple transmit beams. The network node may transmit a reference signal, such as an SSB and/or a channel state information (CSI) reference signal (RS) (CSI-RS) using each transmit beam. The UE may measure a reference signal on different transmit beams using different receive beams to support selection of a beam pair. The UE may report the measurements to the network node.

In some examples, the network node may conserve energy by transmitting different reference signal beams (e.g., SSB beams) using different transmit powers and/or different beam widths. For example, each beam may be associated with a different amount of path loss to mitigate to reach a UE. For example, a signal-to-noise ratio (SNR) associated with a UE served by a particular beam may vary from one beam to another. Thus, the network node may conserve energy by transmitting beams using different transmit powers and/or different beam widths. Further, a quantity of UEs in the coverage area of a particular beam may vary from one beam to another, thus the network node may balance the load of communications across different directions by transmitting different beams using different beam widths. Thus, the network node may use different transmit powers in different directions (e.g., depending on pathloss, load, etc.) to optimize power saving.

In some examples, a UE may transmit, to a network node, an indication of one or more capabilities and/or features supported by the UE, such that the network can configure different communication parameters for different capabilities and/or features, and/or combinations of capabilities and/or features. For example, the UE may transmit a feature combination preamble indicating a set of parameters (e.g., parameters, capabilities, and/or features) prior to establishing a connection with the network node. The network node may configure different communication parameters for different combinations of features such that the UE and the network node may communicate using a set of features that most effectively support efficient communications between the UE and the network node. For example, the preamble may indicate that the UE supports one or more of reduced capability (RedCap) communications, small data transmission (SDT), and/or Msg3 repetition, among other examples.

SDT in wireless communications may refer to the transmission of one or more communications including small amounts of data (e.g., typically in the context of IoT devices or scenarios where minimal data exchange is needed, such as for RedCap UEs, among other examples). For example, a UE may transmit and/or receive one or more relatively small data packets without the full overhead associated with establishing a connection that supports the communication of other types of data packets. In some aspects, a UE enabled with SDT may communicate small data packets and/or signaling while the UE is in an inactive state, such as a radio resource control (RRC) inactive state (e.g., RRC_INACTIVE state), without the UE transitioning to a connected state, such as an RRC connected state (e.g., an RRC_CONNECTED state). In some aspects, the UE may perform contention-based random-access-based SDT and/or configured-grant-based SDT.

For example, a UE in some wireless communication systems (e.g., including NR systems) may perform one or more procedures for establishing a communications link with a network node operating as part of a wireless communication network. The UE may communicate a series of messages with the network node to establish access to the network. In some examples, establishing access to the network may be referred to as initial access. In some examples, the UE may perform a random access procedure to establish access with the network (e.g., to establish a communication connection). In some examples, the random access procedure may also be referred to as a random access channel (RACH) procedure. The UE may perform a RACH procedure including a four-step random access procedure or a two-step random access procedure.

As part of a four-step RACH procedure, the UE may transmit, and the network node may receive, a first message (Msg1) via a physical random access channel (PRACH). Msg1 may include a physical PRACH preamble. The UE may receive, and the network node may transmit, a second message (Msg2) via a physical downlink control channel (PDCCH) or physical downlink shared channel (PDSCH) based on transmitting the Msg1. The Msg 2 may include a random access response (RAR) that schedules a physical uplink shared channel (PUSCH) transmission. The UE may transmit, and the network node may receive, a third message (Msg3) including the PUSCH transmission. The UE may receive, and the network node may transmit, a fourth message (Msg4) that includes a contention resolution message via the PDCCH or PDSCH.

As part of a two-step RACH procedure, the UE may transmit, and the network node may receive, a first message (MsgA) including a PRACH preamble and content similar to the content of Msg3 of the four-step RACH procedure. The MsgA transmission may include two transmissions. For example, a first transmission may include a PRACH preamble via the PRACH, and may include timing information for uplink transmissions (e.g., timing information that enables the network node to set timing advance parameters). A second transmission may include the remaining content of MsgA. For example, the MsgA transmission may additionally include a payload (e.g., a data payload) via the PUSCH that includes at least the Msg3 contents. In some examples, the UE may transmit, and the network node may receive, a second message (MsgB) including content similar to the contents of Msg2 and Msg4 of the four-step RACH procedure.

The UE may support the connected communication mode (e.g., an RRC active mode), the idle communication mode (e.g., an RRC idle mode), and the inactive communication mode (e.g., an RRC inactive mode). The RRC inactive mode may functionally reside between the RRC active mode and the RRC idle mode. The UE may transition between different modes based at least in part on various commands and/or communications received from the network node. For example, during the four-step and/or two-step RACH procedure described above and elsewhere herein, the UE may enter and/or remain in the inactive mode, which may conserve resources otherwise associated with entering the active mode. While performing initial access in the inactive mode, the UE may perform SDT.

However, during a random access small data transmission (RA-SDT) session, the UE may not be enabled to transmit channel quality information to the network node to support beam selection and/or refinement. For example, a CSI measurement configuration (e.g., CSI-MeasConfig) and/or a sounding reference signal (SRS) measurement configuration (e.g., SRS-Config) may be disabled during an RA-SDT session. In some examples, beam refinement may not be enabled during an RA-SDT operation. However, the network node may initially configure a modulation and coding scheme (MCS) for communications during the SDT session based on an SDT reference signal received power (RSRP) threshold. As a result, the network node may iteratively adjust the MCS of the UE during the RA-SDT. The iterative adjustment of MCS to increase throughput may affect how various reference signal beams perform during the RA-SDT.

Configured grant communications may include periodic uplink communications that are configured for a UE, such that the network node does not need to send separate control information to schedule each uplink communication, thereby conserving signaling overhead. In some other examples, configured-grant-based SDT may include communications with the UE in the inactive mode. In some examples, the UE may perform SDT via configured grant resources.

The UE may perform beam management with the network node to identify a most appropriate beam for communications, such as SDT communications, during initial access, handover, and/or via configured grant. The UE 120 may identify a most appropriate beam based on a beam sweeping procedure and/or received power levels associated with each communication beam. However, as UEs and network nodes are developed to enable additional features that help conserve resources in other applications, such features may not be considered when performing a beam selection process. For example, the UE may select a communication beam without taking any additional information into account which may squander potential benefits.

For example, selection of a beam pair may be independent of a feature, a combination of features, and/or a type of the UE, and thus UEs that are different from a baseline UE may select a communication beam that is most suitable for a baseline UE without taking additional considerations into account, which may consume additional resources and/or result in increased link failure probability. Some UEs may perform more efficiently when communicating with wider and/or narrower communication beams during a RACH procedure and/or may perform more efficiently when communicating with narrower and/or wider communication beam during SDT RACH, as an example.

Various aspects relate generally to supporting NES initiatives when communicating with UEs having various capabilities, features, and/or types. Some aspects more specifically relate to beam selection for SDT in which some beams may be more suitable for communications between the UE and the network node based on attributes other than an associated received power. Some aspects more specifically relate to indicating a priority (e.g., which may be related to suitability) for beams that is based on the other attributes, such as beam width, beam load, transmit power, features of the UE, features of the network node, a type of the UE, and/or a type of the network node, among other examples. In some aspects, the UE may receive, from a network node, priority information associated with a first communication beam and a second communication beam. The UE may initiate, with the network node using at least one of the first communication beam or the second communication beam, a small data transmission operation in association with selecting a communication beam according to the priority information. In some aspects, selecting the communication beam according to the priority information is associated with at least one of a feature of the UE, a feature of the network node, or a type of the UE. In some aspects, the priority information may include a communication link quality difference threshold. In some aspects, the network node may transmit a resource allocation indicating a first set of resources corresponding to the first communication beam and a second set of resources corresponding to the second communication beam. In some aspects, the priority information may indicate multiple priorities per communication beam, which may correspond to different combinations of features of the UE, the network node, the type of the UE, etc.

Particular aspects of the subject matter described in this disclosure can be implemented to realize one or more of the following potential advantages. In some examples, the described techniques can be used to increase reliability of communications, enhance throughput, and conserve network energy expenditure. For example, by the UE initiating the SDT operation in association with selecting a communication beam according to the priority information, the UE may increase a reliability and/or throughput associated with the SDT operation by selecting a beam that takes the indicated priority into account. By selecting the communication beam according to at least one of a feature of the UE, a feature of the network node, or a type of the UE, the UE may avoid selecting a communication beam that would be inefficient for certain types of UEs, network nodes, and/or features of the UE and/or network node, thereby avoiding potential link failure and/or increased throughput. By the priority information including a communication link quality difference threshold, the UE may avoid prioritizing a beam that would increase efficiency based on attributes of the UE but may have an insufficient received power, thereby causing the network node to expend additional power resources for the communication beam to reach the UE. By the network node transmitting a resource allocation indicating a first set of resources corresponding to the first communication beam and a second set of resources corresponding to the second communication beam, the network node may balance and/or distribute a total communication load and may avoid overloading a particular communication beam, thereby avoiding link failure. By the priority information indicating multiple priorities per communication beam that correspond to different combinations of features of the UE, the network node, the type of the UE, etc., the UE may have increased flexibility for choosing a communication beam based on whether one or more features of the UE are actively enabled.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the 3GPP. 5G NR may support eMBB access, IoT networks or RedCap device deployments, URLLC applications, and/or massive machine type communications (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

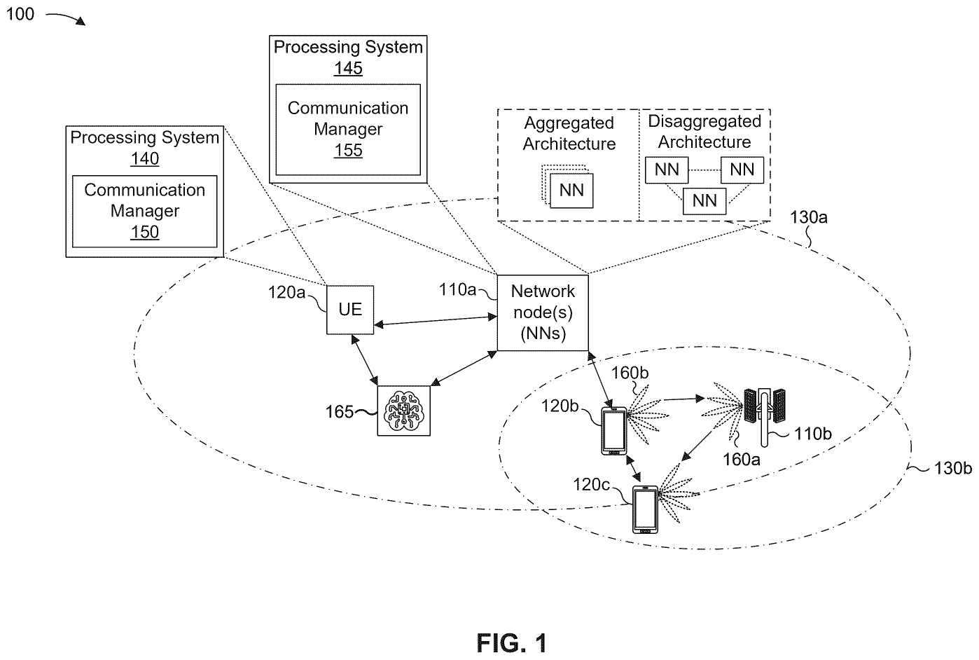

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a RAN. In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

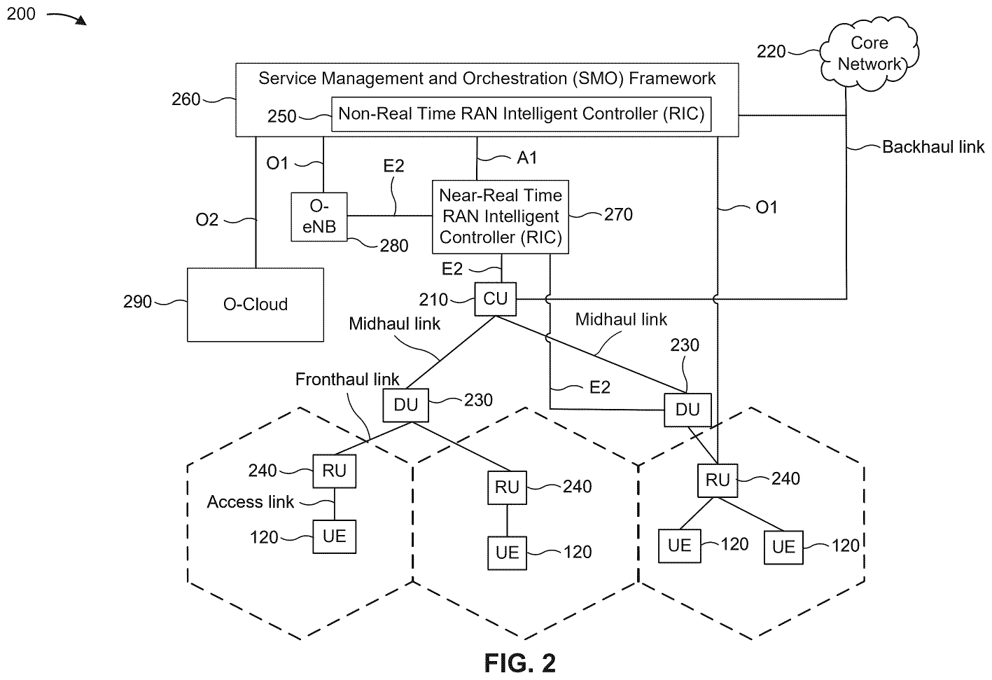

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 and/or a type of the UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a UE 120 in the third category (a RedCap UE) may support lower latency communication than a UE 120 in the first category (an NB-IoT UE or an eMTC UE), and a UE 120 in the second category (a mission-critical IoT UE or a premium UE) may support lower latency communication than the UE 120 in the third category. Additionally or alternatively, in some examples, a UE 120 in the third category (a RedCap UE) may support higher wireless communication throughput than a UE 120 in the first category (an NB-IoT UE or an eMTC UE), and a UE 120 in the second category (a mission-critical IoT UE or a premium UE) may support higher wireless communication throughput than the UE 120 in the third category. Additionally or alternatively, in some examples, a UE 120 in the first category (an NB-IoT UE or an eMTC UE) may support longer battery life than a UE 120 in the third category (a RedCap UE), and the UE 120 in the third category may support longer battery life than a UE 120 in the second category (a mission-critical IoT UE or a premium UE).

In some examples, a UE 120 of the third category (a RedCap UE) may have capabilities that satisfy first device or performance requirements but not second device or performance requirements (such as parameters specified for NR UEs 120 other than UEs 120 of the third category), while a UE 120 of the second category (a mission-critical IoT UE or a premium UE) may have capabilities that satisfy the second device or performance requirements (and also the first device or performance requirements, in some examples). For example, a UE 120 of the third category may support a lower maximum MCS (for example, a modulation scheme such as quadrature phase shift keying (QPSK)) than an MCS supported by a UE 120 of the second category (for example, a modulation scheme such as 256-quadrature amplitude modulation (QAM)). As another example, a UE 120 of the third category may support a lower maximum transmit power than a maximum transmit power of a UE 120 of the second category. As another example, a UE 120 of the third category may have a less advanced beamforming capability than a beamforming capability of a UE 120 of the second category (for example, a RedCap UE may not be capable of forming as many beams as a premium UE). As another example, a UE 120 of the third category may require a longer processing time than a processing time of a UE 120 of the second category. As another example, a UE 120 of the third category may include less hardware or less complex hardware (such as fewer antennas, fewer transmit antennas, and/or fewer receive antennas) than a UE 120 of the second category. As another example, a UE 120 of the third category may not be capable of communicating on as wide of a maximum BWP as a UE 120 of the second category.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a CSI-RS, among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including an MCS or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), a synchronization signal (SS)/physical broadcast channel (PBCH) resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a RACH operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Further efficiencies in throughput, signal strength, and/or other signal properties may be achieved through beam refinement. For example, the network node 110 may be capable of communicating with the UE 120 using beams (for example, beam(s) 160a) of different beam widths. In some examples, the network node 110 may be configured to utilize a wider beam to communicate with the UE 120 when the UE 120 is in motion or for initial beam acquisition because wider coverage may increase the likelihood that the mobile UE 120 remains in coverage of the network node 110 while communicating using the wider beam. Conversely, the network node 110 may use a narrower beam to communicate with the UE 120 when the UE 120 is stationary because the network node 110 can reliably focus coverage on the UE 120 with low or minimal likelihood of the UE 120 moving out of the coverage area of the narrower beam. In some examples, to select a particular beam (for example, from the beam(s) 160a) for communication with a UE 120, the network node 110 may transmit a reference signal, such as an SSB or a CSI-RS, on each of a plurality of beams in a beam-sweeping manner. In some examples, SSBs may be transmitted on wider beams, whereas CSI-RSs may be transmitted on narrower beams. The UE 120 may measure the RSRP or the signal-to-interference-plus-noise ratio (SINR) on each of the beams and transmit a beam measurement report (for example, a Layer 1 (L1) measurement report) to the network node 110 indicating the RSRP or SINR associated with each of one or more of the measured beams. The network node 110 may then select the particular beam for communication with the UE 120 based on the L1 measurement report. In some other examples, when there is channel reciprocity between the uplink and the downlink, the network node 110 may derive the particular beam to communicate with the UE 120 (for example, on both the uplink and downlink) based on uplink measurements of one or more uplink reference signals, such as an SRS, transmitted by the UE 120.

NES and/or network energy efficiency measures are expected to have increased importance in wireless network operations for various reasons, such as climate change mitigation, environmental sustainability, and/or network cost reduction, among other examples. For example, although NR generally offers a significant energy efficiency improvement per gigabyte over previous generations (for example, LTE), new NR use cases and/or the adoption of millimeter wave frequencies may require more network sites, more network antennas, larger bandwidths, and/or more frequency bands, among other examples which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). The largest proportion of energy consumption and/or energy costs are associated with a RAN, which accounts for about half of the energy consumption in a wireless network, with data centers and fiber transport accounting for smaller shares. Accordingly, measures to increase network energy savings and/or improve network energy efficiency are factors that may drive adoption and/or expansion of wireless networks.

In some examples, a UE 120 or network node 110 may implement power saving features (also referred to as energy saving features). Power saving features may include, for example, relaxed radio resource monitoring (such as relaxed reference signal monitoring for devices operating in low mobility or in good radio conditions), DRX operation, reduced PDCCH monitoring during DRX active times, on-demand system information transmission, on-demand SSB transmission, antenna port adaptation, advanced CSI reporting, and/or power-efficient paging reception.

In some examples, a UE 120 may operate in association with a DRX configuration (for example, indicated to the UE 120 by a network node 110). DRX operation may enable the UE 120 to enter a sleep mode or state at various times while in the coverage area of a network node 110 to reduce power consumption for conserving battery resources, among other examples. The DRX configuration generally configures the UE 120 to operate in association with a DRX cycle. The UE 120 may repeat DRX cycles with a configured periodicity according to the DRX configuration. A DRX cycle may include a DRX on duration during which the UE 120 is in an awake mode or in an active state. A DRX cycle may also include one or more durations during which the UE 120 may operate in an inactive state. The one or more durations in which the UE 120 may operate in an inactive state may be opportunities for the UE 120 to enter a DRX sleep mode in which the UE 120 may refrain from monitoring for communications from a network node 110. Additionally or alternatively, the UE 120 may deactivate one or more antennas, RF chains, and/or other hardware components or devices while operating in the DRX sleep mode.

The time during which the UE 120 is configured to be in an active state during a DRX on duration may be referred to as an active time, and the time during which the UE 120 is configured to be in an inactive state, such as during a DRX sleep duration, may be referred to as an inactive time. During a DRX on duration, the UE 120 may monitor for downlink communications from one or more network nodes 110. If the UE 120 does not detect and/or does not successfully decode any downlink communications during the DRX on duration, the UE 120 may enter a DRX sleep mode for the inactive time duration at the end of the DRX on duration. If the UE 120 detects and/or successfully decodes a downlink communication during the DRX on duration, the UE 120 may remain in the active state for the duration of a DRX inactivity timer (which may extend the active time). The UE 120 may start the DRX inactivity timer at a time at which the downlink communication is received. The UE 120 may remain in the active state until the DRX inactivity timer expires, at which time the UE 120 may transition to the sleep mode for an inactive time duration. Additionally or alternatively, the UE 120 may use a DRX cycle referred to as an extended DRX (eDRX) cycle, such as for use cases that are tolerant to latency. An eDRX cycle may include a relatively longer inactive time relative to a baseline DRX cycle (for example, an eDRX cycle may have a lower ratio of active time to inactive time).

In some aspects, the UE 120 may include a communication manager 150. As described in more detail elsewhere herein, the communication manager 150 may receive, from a network node, priority information associated with a first communication beam and a second communication beam; and initiate, with the network node using at least one of the first communication beam or the second communication beam, a small data transmission operation in association with selecting a communication beam according to the priority information. Additionally, or alternatively, the communication manager 150 may perform one or more other operations described herein.

In some aspects, the network node 110 may include a communication manager 155. As described in more detail elsewhere herein, the communication manager 155 may transmit, to a UE, priority information associated with a first communication beam and a second communication beam; and perform, via a communication beam that is selected by the UE, a small data transmission operation according to the priority information, wherein the communication beam includes at least one of the first communication beam or the second communication beam. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

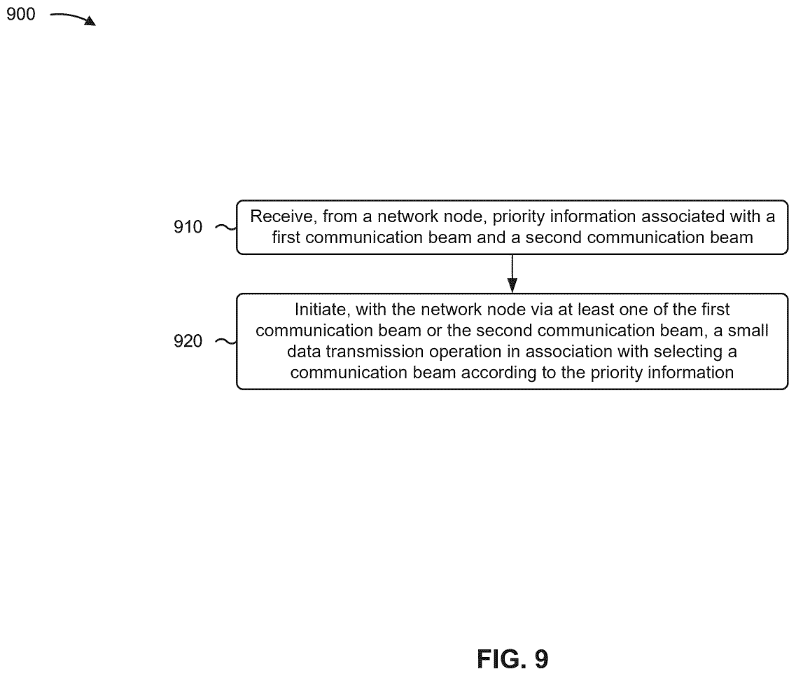

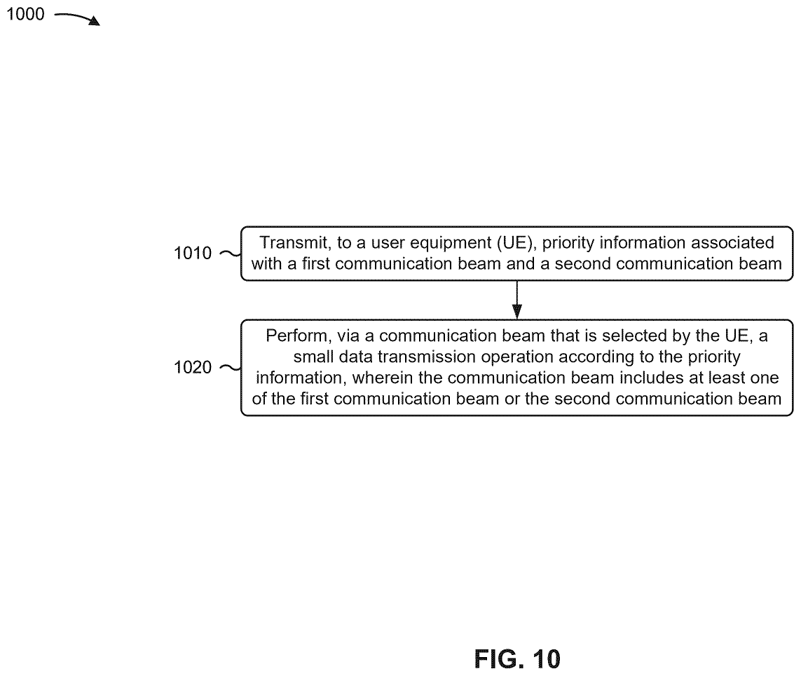

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with beam selection for SDT, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

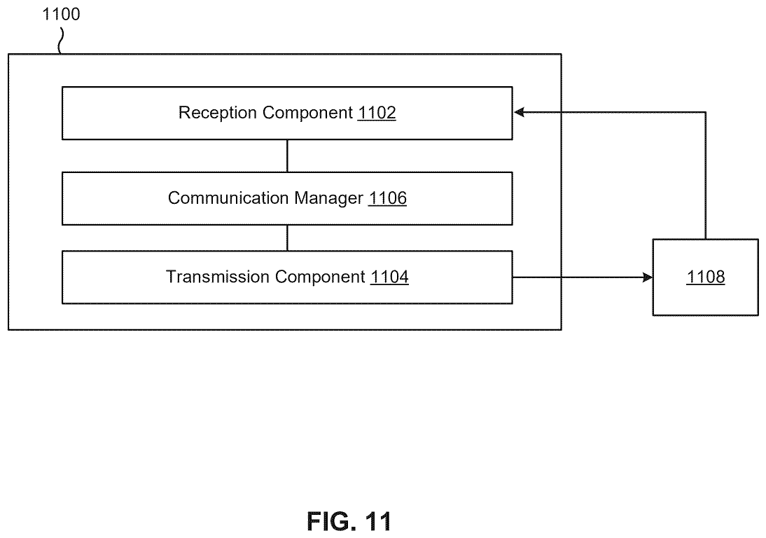

In some aspects, a UE (e.g., the UE 120) includes means for receiving, from a network node, priority information associated with a first communication beam and a second communication beam; and/or means for initiating, with the network node via at least one of the first communication beam or the second communication beam, an SDT operation in association with selecting a communication beam according to the priority information. The means for the UE to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

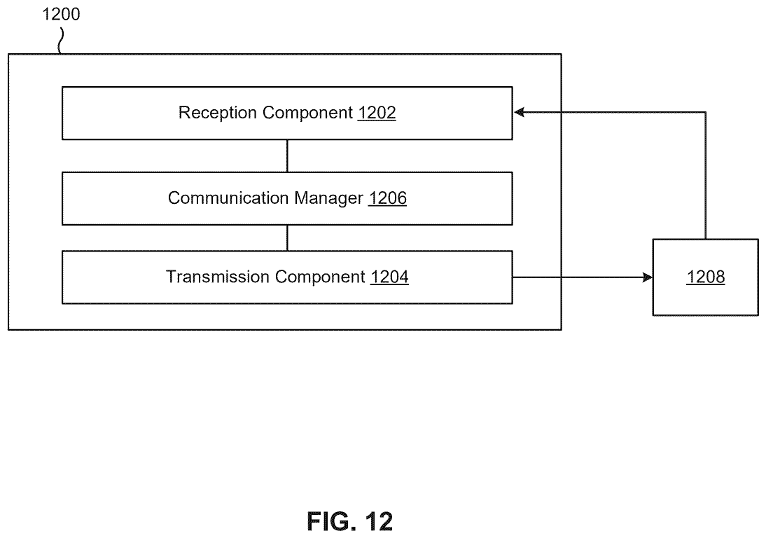

In some aspects, a network node (e.g., the network node 110) includes means for transmitting, to a UE, priority information associated with a first communication beam and a second communication beam; and/or means for performing, via a communication beam that is selected by the UE, an SDT operation according to the priority information, wherein the communication beam includes at least one of the first communication beam or the second communication beam. The means for the network node to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

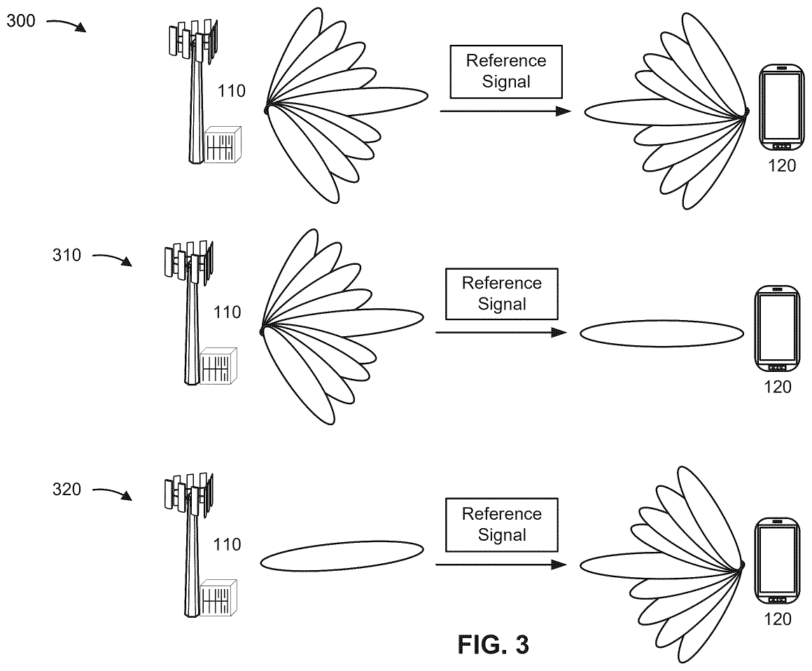

FIG. 3 is a diagram illustrating examples 300, 310, and 320 of reference signal (e.g., CSI-RS, SSB) beam management procedures, in accordance with the present disclosure. As shown in FIG. 3, examples 300, 310, and 320 include a UE 120 in communication with a network node 110 in a wireless network (e.g., wireless network 100). However, the devices shown in FIG. 3 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, and/or between a scheduled node and a scheduling node). In some aspects, the UE 120 and the network node 110 may be in a connected state (e.g., an RRC connected state).

As shown in FIG. 3, example 300 may include a network node 110 (e.g., one or more network node devices such as an RU, a DU, and/or a CU, among other examples) and a UE 120 communicating to perform beam management using reference signals. Example 300 depicts a first beam management procedure (e.g., P1 reference signal beam management). The first beam management procedure may be referred to as a beam selection procedure, an initial beam acquisition procedure, a beam sweeping procedure, a cell search procedure, and/or a beam search procedure. As shown in FIG. 3 and example 300, reference signals may be configured to be transmitted from the network node 110 to the UE 120. The reference signals may be configured to be periodic (e.g., using RRC signaling), semi-persistent (e.g., using media access control (MAC) control element (MAC-CE) signaling), and/or aperiodic (e.g., using DCI).

The first beam management procedure may include the network node 110 performing beam sweeping over multiple transmit (Tx) beams. The network node 110 may transmit a reference signal using each transmit beam for beam management. To enable the UE 120 to perform receive (Rx) beam sweeping, the network node may use a transmit beam to transmit (e.g., with repetitions) each reference signal at multiple times within the same RS resource set so that the UE 120 can sweep through receive beams in multiple transmission instances. For example, if the network node 110 has a set of N transmit beams and the UE 120 has a set of M receive beams, the reference signal may be transmitted on each of the N transmit beams M times so that the UE 120 may receive M instances of the reference signal per transmit beam. In other words, for each transmit beam of the network node 110, the UE 120 may perform beam sweeping through the receive beams of the UE 120. As a result, the first beam management procedure may enable the UE 120 to measure a reference signal on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 300 has been described in connection with generic reference signals, the first beam management process may use CSI-RSs and/or SSBs for beam management in a similar manner as described above.

As shown in FIG. 3, example 310 may include a network node 110 and a UE 120 communicating to perform beam management using reference signals. Example 310 depicts a second beam management procedure (e.g., P2 reference signal beam management). The second beam management procedure may be referred to as a beam refinement procedure, a network node beam refinement procedure, a TRP beam refinement procedure, and/or a transmit beam refinement procedure. As shown in FIG. 3 and example 310, reference signals may be configured to be transmitted from the network node 110 to the UE 120. The reference signals may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a reference signal using each transmit beam of the one or more transmit beams for beam management. The UE 120 may measure each reference signal using a single (e.g., a same) receive beam (e.g., determined based at least in part on measurements performed in connection with the first beam management procedure). The second beam management procedure may enable the network node 110 to select a best transmit beam based at least in part on measurements of the reference signals (e.g., measured by the UE 120 using the single receive beam) reported by the UE 120.

As shown in FIG. 3, example 320 depicts a third beam management procedure (e.g., P3 reference signal beam management). The third beam management procedure may be referred to as a beam refinement procedure, a UE beam refinement procedure, and/or a receive beam refinement procedure. As shown in FIG. 3 and example 320, one or more reference signals may be configured to be transmitted from the network node 110 to the UE 120. The reference signals may be configured to be aperiodic (e.g., using DCI). The third beam management process may include the network node 110 transmitting the one or more reference signals using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) reference signal at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the reference signal of the transmit beam using the one or more receive beams).

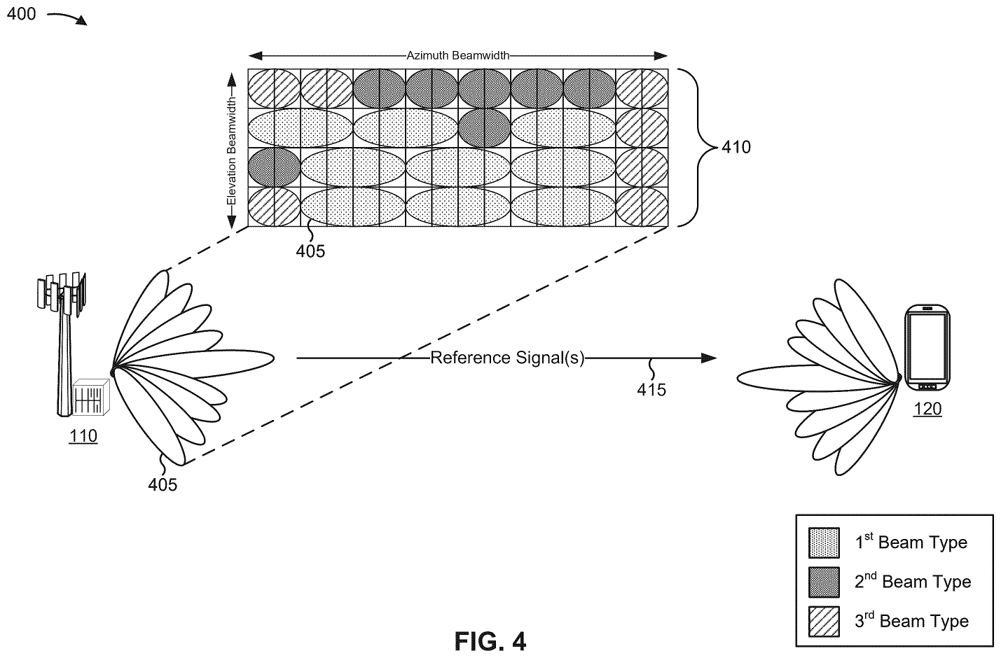

The network node 110 may conserve energy by transmitting different reference signal beams (e.g., SSB beams) using different transmit powers and/or different beam widths, as further discussed with reference to FIG. 4. As a result, the UE 120 may prioritize reference signal beams according to several factors. For example, a wider reference signal beam may be associated with a higher priority because the network node 110 may be enabled to refine a wider beam (e.g., transmit the beam using a different width to increase link quality) relatively quickly to higher link gain for the UE 120. In such examples, reperforming the beam management procedure in response to degrading link quality would consume more resources than refining an existing beam link. Further, the wider reference signal beam may be prioritized higher because the UE 120 may be located in the coverage area of the wider reference signal beam for a longer duration of time and thus may be less likely to experience beam failure in comparison to the narrower reference signal beam (e.g., which may be associated with a smaller coverage area than the wider reference signal beam).

Each of the two reference signal beams may additionally or alternatively be associated with different loads. For example, if each of the two reference signal beams corresponds to a similar quantity of resources (e.g., RACH resources), the less congested Tx beam may be prioritized in some scenarios (e.g., to some network nodes 110 and/or in some networks) because the subsequent access procedure (e.g., RACH procedure and/or handover procedure) may be less affected by congestion (and thus, less likely to experience link failure and/or degradation). In some other scenarios, the more congested reference signal beam may be prioritized in some scenarios (e.g., to some network nodes 110 and/or in some networks) because the network node 110 may be enabled to serve (e.g., communicate with) more UEs using beams having relatively more congestion (e.g., higher load). As a result, some reference signal beams may be more suitable for communications based on information (e.g., in addition to channel quality) that is unavailable at the UE 120 (e.g., beam width, transmit power, beam load).

Thus, it may be beneficial for the network node 110 to configure and/or indicate an abstract priority (e.g., a priority communicated without contextual information regarding why the priority was identified) per beam in order to disincentivize the UE 120 from selecting less suitable communication beams.

As indicated above, FIG. 3 is provided as an example of beam management procedures. Other examples of beam management procedures may differ from what is described with respect to FIG. 3. For example, the UE 120 and the network node 110 may perform the third beam management procedure before performing the second beam management procedure, and/or the UE 120 and the network node 110 may perform a similar beam management procedure to select a UE transmit beam.

FIG. 4 is a diagram illustrating an example 400 of a hybrid beamforming codebook, in accordance with the present disclosure. As shown in FIG. 4, a network node 110 (e.g., one or more network node devices such as an RU, a DU, and/or a CU, among other examples) and a UE 120 may communicate with one another.

The example 400 may illustrate the network node 110 and a UE 120 communicating to perform beam management using reference signals (e.g., CSI-RS, SSBs). The example 400 may include aspects of example 300 and/or the first beam management procedure, as described with reference to FIG. 3. The network node 110 may perform beam sweeping over multiple Tx beams 405. The network node 110 may transmit a reference signal using each transmit beam 405.

Each Tx beam 405 may be associated with a different amount of path loss to mitigate to reach the UE 120. For example, an SNR of a UE 120, among the UEs 120 served by a particular Tx beam 405, may vary from one Tx beam 405 to another. Thus, the network node 110 may conserve energy by transmitting Tx beams 405 using different transmit powers and/or different beam widths. Further, a quantity of UEs in the coverage area of a particular Tx beam 405 may vary from one Tx beam 405 to another, thus the network node 110 may balance the load of communications across different directions by transmitting different Tx beams 405 using different beam widths. Thus, the network node 110 may use different transmit powers in different directions (e.g., depending on pathloss, load, etc.) to optimize power saving.

The network node 110 may configure and/or be configured with a hybrid codebook 410 that represents the different transmit beams 405. For example, as shown by reference number 415, the network node 110 may transmit reference signals via different Tx beams 405 using different beam widths and/or transmit powers to conserve energy consumed by the operations of the network node 110. In some examples, the Tx beams 405 may span a combined elevational distance of 0 to 30 degrees with respect to the network node 110, such that each Tx beam 405 spans an elevational beam width of 7.5 degrees, and may span a combined azimuthal distance of 0 to 120 degrees with respect to the network node 110. The hybrid codebook 410 may represent beams having different beam widths and/or transmit powers. For example, the hybrid codebook may include a first set of Tx beams having a set of characteristics in common, such as a first beam width and a first transmit power, a second set of Tx beams having a set of characteristics in common, such as a second beam width and a second transmit power, and a third set of Tx beams having a set of characteristics in common, such as the first beam width and a third transmit power. Each Tx beam 405 in the first set of communication beams, the second set of communication beams, and/or the third set of communication beams may be associated with a different beam direction (e.g., may be associated with a unique combination of azimuthal beam width and/or elevation beam width).

The UE 120 may perform beam management with the network node 110 to identify a most appropriate beam for communications between the network node 110 and the UE 120, as described with reference to FIG. 3. As used herein, the UE 120 “selecting” and/or “prioritizing” a communication beam refers to the UE 120 identifying, and/or reporting to the network node 110, a most suitable Rx beam corresponding to the Tx beams 405 to enable the network node 110 to select one or more beam pair(s) for communication between the network node 110 and the UE 120. In some examples, selection of a beam pair may be independent of a feature, a combination of features, and/or a type of the UE 120 and thus UEs 120 that are different from a baseline UE may select a communication beam that is most suitable for a baseline UE without taking additional considerations into account which may consume additional resources and/or result in increased link failure probability.

Thus, it may be beneficial for the network node 110 to configure and/or indicate an abstract priority (e.g., a priority communicated without contextual information regarding why the priority was identified) per beam that corresponds to one or more features of the UE 120 to disincentivize the UE 120 from selecting less suitable communication beams.

As a result, the UE 120 may use a beam selection strategy that is dependent on a type of the UE (e.g., reduced capability UE, companion UE, wearable UE, mobile device), one or more capabilities and/or features of the UE 120 (e.g., RedCap, SDT, Msg2 retransmission), and/or a usage of the UE. For example, a beam that is most suitable for communications during a RACH procedure may be less suitable for communications during an SDT RACH procedure. The UE 120 may select a wider beam for communications during a RACH procedure and/or may select a narrower beam for communications during an SDT RACH procedure, and/or may select a narrower beam for communications during a RACH procedure and/or may select a wider beam for communications during an SDT RACH procedure. Additionally or alternatively, the network node 110 may incentivize the UE 120 to prioritize communication beams differently for load balancing by configuring resources differently for different communication beams.

As indicated above, FIG. 4 is provided as an example. Other examples may differ from what is described with respect to FIG. 4.

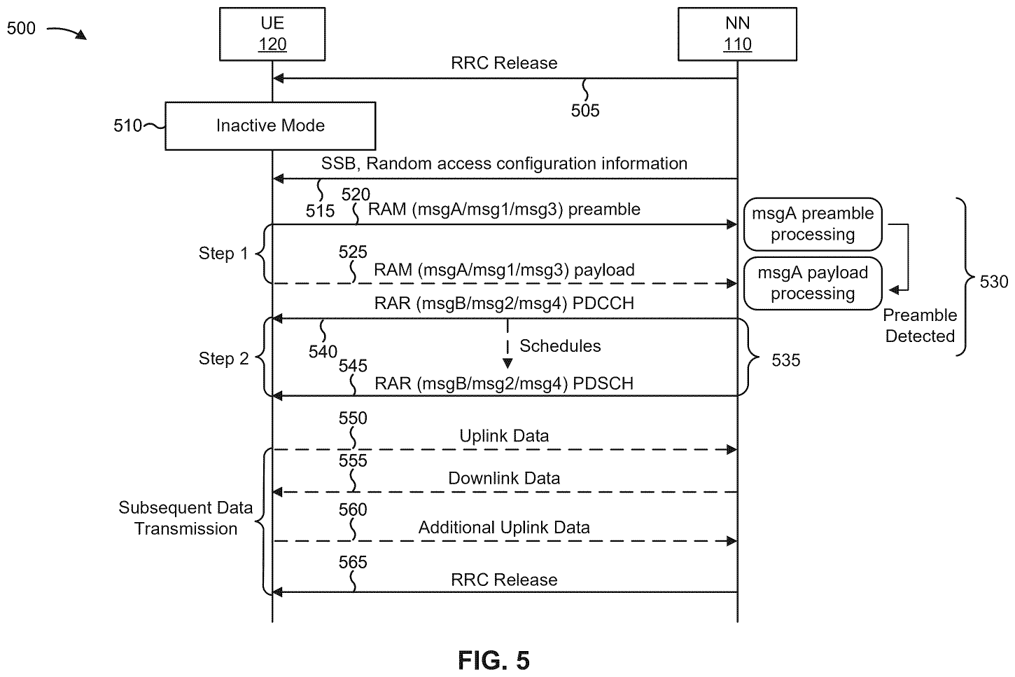

FIG. 5 is a diagram illustrating an example 500 including aspects of a two-step random access procedure and a four-step random access procedure that supports SDT, in accordance with the present disclosure. As shown in FIG. 5, a network node 110 and a UE 120 may communicate with one another to perform the two-step random access procedure and/or the four-step random access procedure. The UE 120 may support a connected communication mode (e.g., an RRC active mode), an idle communication mode (e.g., an RRC idle mode), and an inactive communication mode (e.g., an RRC inactive mode). The RRC inactive mode may functionally reside between the RRC active mode and the RRC idle mode.

The UE 120 may transition between different modes based at least in part on various commands and/or communications received from the network node 110. As shown by reference number 505, the network node 110 may transmit, and the UE 120 may receive, an RRC release message (e.g., RRCRelease). In some examples, the RRC release message may include a suspension message (e.g., SuspendConfig) that suspends a configuration of the UE 120. As shown by reference number 510, in association with receiving the RRC release message, the UE 120 may enter an inactive mode (e.g., RRC_INACTIVE mode). For example, the UE 120 may transition from RRC active mode to RRC inactive mode based at least in part on receiving an RRC release message including a suspension message (e.g., SuspendConfig).

When transitioning to RRC inactive mode, the UE 120 and/or the network node 110 may store a UE context (e.g., an access stratum (AS) context and/or higher-layer configurations). This permits the UE 120 and/or the network node 110 to apply the stored UE context when the UE 120 transitions from RRC inactive mode to RRC active mode in order to resume communications, which reduces latency of transitioning to RRC active mode relative to transitioning to the RRC active mode from RRC idle mode. While in the RRC inactive mode, the UE 120 may perform random-access-based SDT. For example, the UE 120 may perform a four-step random access procedure and/or a two-step random access procedure including the transmission of small data without transitioning into the RRC active mode.

As shown by reference number 515, the network node 110 may transmit, and the UE 120 may receive, one or more SSBs and/or random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure and/or the four-step random access procedure, such as one or more parameters for transmitting a random access message (RAM) and/or receiving an RAR to the RAM.

In some examples, the UE 120 may measure a reference signal received power (RSRP) of the one or more SSBs described in connection with reference number 515. In such examples, the UE 120 may initiate RA-SDT when it has a small data payload to communicate to the network node 110, and/or when a measured RSRP of the one or more SSBs satisfies an SDT-RSRP threshold.

As shown by reference number 520, in the example of a two-step random access procedure, the UE 120 may transmit, and the network node 110 may receive, a RAM preamble. As shown by reference number 525, in the example of a two-step random access procedure, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, UCI, and/or a PUSCH) transmission.

As shown by reference number 520 and/or reference number 525, in the example of a four-step random access procedure, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 520, in the example of a two-step random access procedure and/or reference number 525, in the example of a four-step random access procedure, the UE 120 may transmit an RRC connection request message. The RRC connection request message may be referred to as message 3, msg3, MSG3, or a third message of a four-step random access procedure. In some aspects, the RRC connection request (e.g., an RRC connection request, an RRC resume request) may include a UE identifier, UCI, and/or a PUSCH communication.

As shown by reference number 530, in the example of a two-step random access procedure, the network node 110 may receive the RAM preamble transmitted by the UE 120. If the network node 110 successfully receives and decodes the RAM preamble, the network node 110 may then receive and decode the RAM payload.

As shown by reference number 535, in the example of a two-step random access procedure, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of the four-step random access procedure. For example, the RAR message may include the detected PRACH preamble identifier, the detected UE identifier, a timing advance value, and/or contention resolution information.

However, for RA-SDT, msgB and/or msg4 does not include an RRC signaling message. Additionally or alternatively, the network node 110 may otherwise transmit RRC signaling to transition the UE 120 to the RRC connected state.

As shown by reference number 540, in the example of a two-step random access procedure, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (e.g., in DCI) for the PDSCH communication.

As shown by reference number 540 and/or reference number 545, in the example of a four-step random access procedure, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 545, in the example of a two-step random access procedure, as part of the second step of the two-step random access procedure, the network node 110 may transmit the PDSCH communication for the RAR, as scheduled by the PDCCH communication. The RAR may be included in a MAC PDU of the PDSCH communication. As shown by reference number 540, if the UE 120 successfully receives the RAR, the UE 120 may transmit a hybrid automatic repeat request (HARQ) ACK.

As shown by reference number 540 and/or 545, in the example of a four-step random access procedure, the network node 110 may transmit an RRC connection setup message. The RRC connection setup message may be referred to as message 4, msg4, MSG4, or a fourth message of a four-step random access procedure.

As shown by reference number 550, the UE 120 may perform SDT by transmitting a first uplink data message to the network node 110.

As shown by reference number 555, the network node 110 may transmit, and the UE 120 may receive, a downlink data message (e.g., in response to the uplink data described in connection with reference number 550).

As shown by reference number 560, the UE 120 may transmit, and the network node 110 may receive, additional uplink data. After MsgB/Msg4, SDT may be performed until an RRC message is received and/or a timer (e.g., t319-a timer) expires. For example, as shown by reference number 565, the network node 110 may transmit, and the UE 120 may receive, an RRC release message, which may end SDT between the UE 120 and the network node 110.

During an RA-SDT session, the UE 120 may not be enabled to transmit channel quality information to the network node 110. For example, a CSI measurement configuration (e.g., CSI-MeasConfig) and/or an SRS measurement configuration (e.g., SRS-Config) may be disabled during an RA-SDT session. In some examples, beam refinement may not be enabled during an RA-SDT operation. However, the network node 110 may initially configure an MCS for communications during the SDT session based on the SDT RSRP threshold. As a result, the network node 110 may iteratively adjust the MCS of the UE 120 during the RA-SDT session based on an error rate pass/fail condition (e.g., cyclic redundancy check (CRC) pass/fail condition). The iterative adjustment of MCS to satisfy a channel quality metric while increasing throughput may affect how various reference signal beams are prioritized and/or selected by the UE 120 in the initial stages of an RA-SDT procedure.

As indicated above, FIG. 5 is provided as an example. Other examples may differ from what is described with regard to FIG. 5.

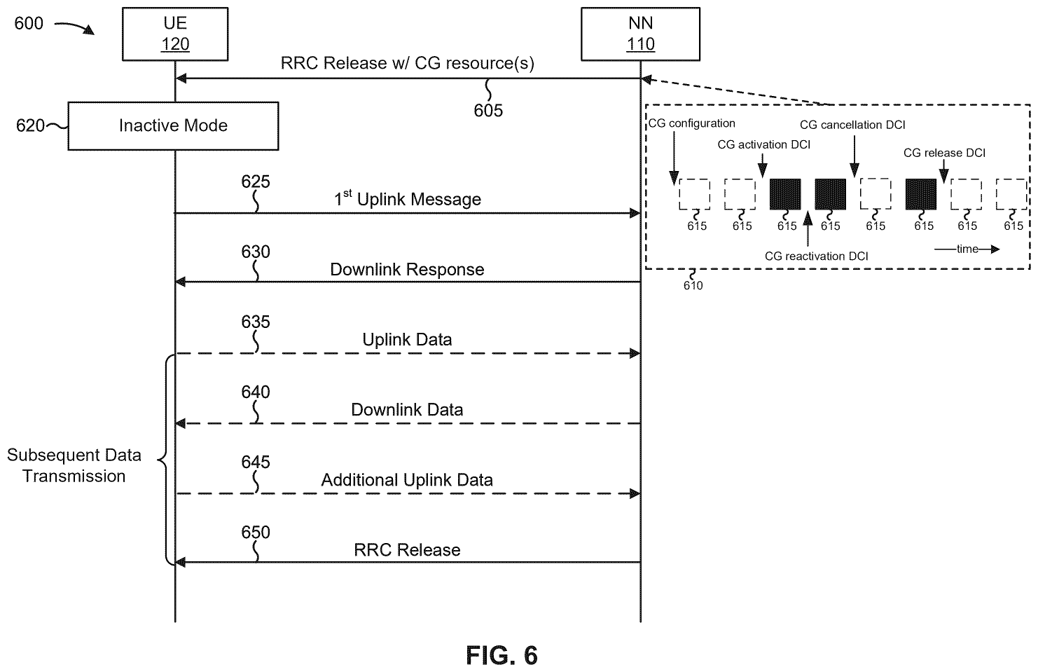

FIG. 6 is a diagram illustrating an example 600 of uplink configured grant (CG) communication that supports SDT, in accordance with the present disclosure, in accordance with the present disclosure. As shown in FIG. 6, a network node 110 and a UE 120 may communicate with one another. CG communications may include periodic uplink communications that are configured for a UE 120, such that the network node 110 does not need to send separate DCI to schedule each uplink communication, thereby conserving signaling overhead.

As shown by reference number 605, the network node 110 may transmit, and the UE 120 may receive, an RRC release message (e.g., RRCRelease). In some examples, the RRC release message may include a suspension message (e.g., SuspendConfig) that suspends a configuration of the UE 120. In some examples, the RRC release message may include a CG resource configuration 610. The CG resource configuration 610 may indicate a resource allocation associated with CG uplink communications (e.g., in a time domain, frequency domain, spatial domain, and/or code domain) and a periodicity at which the resource allocation is repeated, resulting in periodically reoccurring scheduled CG occasions 615 for the UE 120. In some examples, the CG configuration 610 may identify a resource pool or multiple resource pools that are available to the UE 120 for an uplink transmission. The CG configuration 610 may configure contention-free CG communications (e.g., where resources are dedicated for the UE 120 to transmit uplink communications) or contention-based CG communications (e.g., where the UE 120 contends for access to a channel in the configured resource allocation, such as by using a channel access procedure or a channel sensing procedure).

The network node 110 may transmit CG activation DCI to the UE 120 to activate the CG configuration 610 for the UE 120. The network node 110 may indicate, in the CG activation DCI, communication parameters, such as an MCS, a resource block (RB) allocation, and/or antenna ports, for the CG PUSCH communications to be transmitted in the scheduled CG occasions 615. The UE 120 may begin transmitting in the CG occasions 615 based at least in part on receiving the CG activation DCI. For example, beginning with a next scheduled CG occasion 615 subsequent to receiving the CG activation DCI, the UE 120 may transmit a PUSCH communication in the scheduled CG occasions 615 using the communication parameters indicated in the CG activation DCI. The UE 120 may refrain from transmitting in configured CG occasions 615 prior to receiving the CG activation DCI.

The network node 110 may transmit CG reactivation DCI to the UE 120 to change the communication parameters for the CG PUSCH communications. Based at least in part on receiving the CG reactivation DCI, the UE 120 may begin transmitting in the scheduled CG occasions 615 using the communication parameters indicated in the CG reactivation DCI. For example, beginning with a next scheduled CG occasion 615 subsequent to receiving the CG reactivation DCI, the UE 120 may transmit PUSCH communications in the scheduled CG occasions 615 based at least in part on the communication parameters indicated in the CG reactivation DCI.

In some cases, such as when the network node 110 needs to override a scheduled CG communication for a higher priority communication, the network node 110 may transmit CG cancellation DCI to the UE 120 to temporarily cancel or deactivate one or more subsequent CG occasions 615 for the UE 120. The CG cancellation DCI may deactivate only a subsequent one CG occasion 615 or a subsequent N CG occasions 615 (where N is an integer). CG occasions 615 after the one or more (e.g., N) CG occasions 615 subsequent to the CG cancellation DCI may remain activated. Based at least in part on receiving the CG cancellation DCI, the UE 120 may refrain from transmitting in the one or more (e.g., N) CG occasions 615 subsequent to receiving the CG cancellation DCI. As shown in example 600, the CG cancellation DCI cancels one subsequent CG occasion 615 for the UE 120. After the CG occasion 615 (or N CG occasions) subsequent to receiving the CG cancellation DCI, the UE 120 may automatically resume transmission in the scheduled CG occasions 615.

The network node 110 may transmit CG release DCI to the UE 120 to deactivate the CG configuration 610 for the UE 120. The UE 120 may stop transmitting in the scheduled CG occasions 615 based at least in part on receiving the CG release DCI. For example, the UE 120 may refrain from transmitting in any scheduled CG occasions 615 until another CG activation DCI is received from the network node 110. Whereas the CG cancellation DCI may deactivate only a subsequent one CG occasion 615 or a subsequent N CG occasions 615, the CG release DCI deactivates all subsequent CG occasions 615 for a given CG configuration 610 for the UE 120 until the given CG configuration 610 is activated again by a new CG activation DCI.

The messages shown in the context of CG configuration 610 may be dispersed throughout the example 600 and may be interspersed with one or more communications of the CG-SDT session.

As shown by reference number 620, in association with receiving the RRC release message, the UE 120 may enter an inactive mode (e.g., RRC_INACTIVE mode). For example, the UE 120 may transition from RRC active mode to RRC inactive mode based at least in part on receiving an RRC release message including a suspension message (e.g., SuspendConfig).

As shown by reference number 625, the UE 120 may transmit, and the network node 110 may receive, a first uplink message via a CG resource 615. For example, the first uplink message may include a CG transmission including an RRC resume request message and/or uplink data.

As shown by reference number 630, the network node 110 may transmit, and the UE 120 may receive, a downlink response message. For example, the downlink response message may include a dynamic grant for a new uplink transmission outside of the CG and/or a dynamic grant for one or more retransmissions.

The UE 120 may perform CG-SDT when there is an uplink data payload for transmission to the network node 110 and/or when any CG-SDT conditions are satisfied. In such examples, the UE 120 may transmit data via the CG resources 615 (e.g., configured CG-SDT PUSCH resources) while remaining in the RRC inactive mode (e.g., RRC_INACTIVE).

As shown by reference number 635, the UE 120 may perform SDT by transmitting a first uplink data message to the network node 110 via one or more CG resources 615.

As shown by reference number 640, the network node 110 may transmit, and the UE 120 may receive, a downlink data message (e.g., in response to the uplink data described in connection with reference number 635).

As shown by reference number 645, the UE 120 may transmit, and the network node 110 may receive, additional uplink data via one or more CG resources 615. As shown by reference number 650, the network node 110 may transmit, and the UE 120 may receive, an RRC release message, which may end CG-SDT between the UE 120 and the network node 110.

In combination with the beamforming procedures described in FIGS. 3 and/or 4, in some aspects, the CG resources 615 may be distributed equally among communication beams and/or a periodicity of CG resources 615 may be the same for each communication beam. However, adjusting a quantity of resources and/or a periodicity of resources for each communication beam may support load balancing in combination with the prioritization of different SSBs, which may beneficially increase NES effects.

As indicated above, FIG. 6 is provided as an example. Other examples may differ from what is described with respect to FIG. 6.

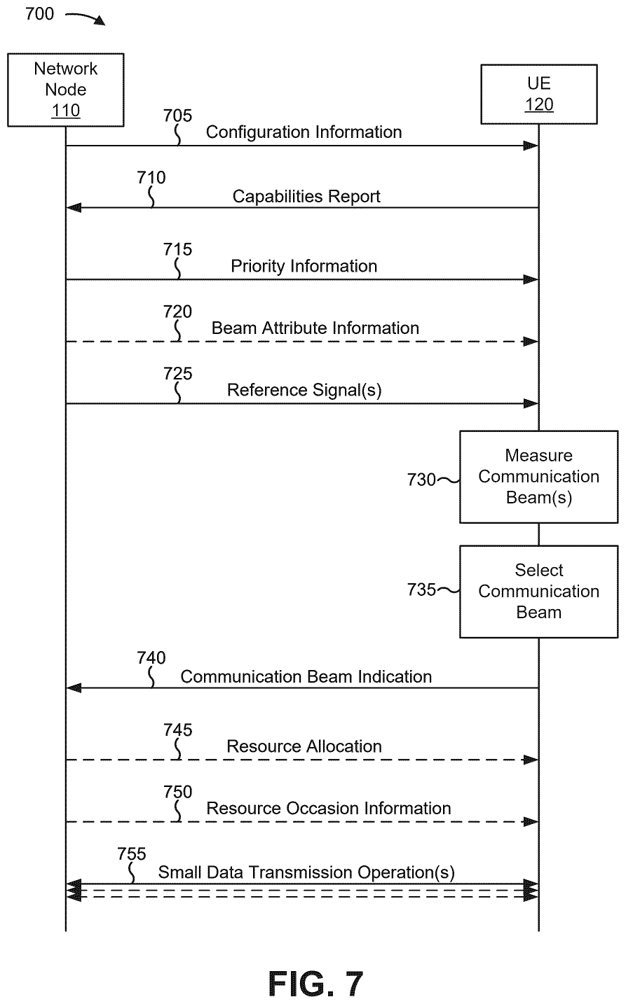

FIG. 7 is a diagram of an example 700 associated with priority-based beam selection for SDT, in accordance with the present disclosure. As shown in FIG. 7, a network node 110 (e.g., a network node 110 described in connection with FIG. 1, a CU, a DU, and/or an RU) may communicate with a UE 120 (e.g., UE 120 described in connection with FIG. 1). In some aspects, the network node 110 and the UE 120 may be part of a wireless communications network (e.g., wireless network 100 described in connection with FIG. 1). The UE 120 and the network node 110 may have established a wireless connection prior to operations shown in FIG. 7.

As shown by reference number 705, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, one or more medium access control (MAC) control elements (CEs), and/or downlink control information (DCI), among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC CEs and/or one or more DCI messages, among other examples.

In some aspects, the configuration information may indicate that the UE 120 is to prioritize reference signal beams differently during a beam selection procedure based on one or more characteristics and/or capabilities of the UE 120, one or more characteristics and/or capabilities of the network node 110, and/or one or more beam characteristics, such as beam width, beam load, and/or transmit power.

The UE 120 may configure itself based at least in part on the configuration information. In some aspects, the UE 120 may be configured to perform one or more operations described herein based at least in part on the configuration information.

As shown by reference number 710, the UE 120 may transmit, and the network node 110 may receive, a capabilities report. The capabilities report may indicate whether the UE 120 supports a feature and/or one or more parameters related to the feature. For example, the capability information may indicate a capability and/or parameter for feature-based beam prioritization. As another example, the capabilities report may indicate a capability and/or parameter for beam selection and/or prioritization for SDT. One or more operations described herein may be based on capability information of the capabilities report. For example, the UE 120 may perform a communication in accordance with the capability information, or may receive configuration information that is in accordance with the capability information. In some aspects, the capabilities report may indicate UE support for receiving priority information and/or beam characteristic information.

In some aspects, the configuration information described in connection with reference number 705 and/or the capabilities report described in connection with reference number 710 may include information transmitted via multiple communications. Additionally, or alternatively, the network node 110 may transmit the configuration information, or a communication including at least a portion of the configuration information, before and/or after the UE 120 transmits the capabilities report. For example, the network node 110 may transmit a first portion of the configuration information before the capabilities report, the UE may transmit at least a portion of the capabilities report, and the network node 110 may transmit a second portion of the configuration information after receiving the capabilities report.

As shown by reference number 715, the network node 110 may transmit, and the UE 120 may receive, priority information. In some aspects, the network node 110 may transmit, and the UE 120 may receive, priority information associated with a first communication beam and a second communication beam. For example, the priority information may include a first abstract priority that is associated with the first communication beam and a second abstract priority that is associated with the second communication beam. In some aspects, the first communication beam may include a first SSB beam and/or a first CSI-RS beam, and the second communication beam may include a second SSB beam and/or a second CSI-RS beam. The priority information may correspond to a feature of the UE 120, a feature of the network node 110, and/or a type of the UE. For example, the priority information may include one or more priorities for each communication beam that accounts for capabilities of the UE 120, capabilities of the network node 110, and/or a type of the UE 120 such that each communication beam may be associated with multiple priorities. In a first example, the first communication beam and/or the second communication beam may each be associated with a first priority for UEs that are enabled with SDT, and may each be associated with a second priority for UEs for which SDT is disabled. In a second example, the first communication beam and/or the second communication beam may each be associated with a first priority for network nodes that are configured to iteratively adjust MCS during an SDT procedure, and may each be associated with a second priority for network nodes for which iterative MCS is disabled. In a third example, the first communication beam and/or the second communication beam may each be associated with a first priority for a first UE type, and may each be associated with a second priority for a second UE type.

In some aspects, the first communication beam and/or the second communication beam may be and/or may be associated with a reference signal beam as described with reference to FIG. 3.

In some aspects, receiving the priority information may include receiving an SIB including the priority information. In some aspects, receiving the priority information may include receiving, while operating in at least one of an RRC inactive mode or a handover mode, RRC signaling including the priority information. In some aspects, the priority information may be received as part of the configuration information described in connection with reference number 705.

In some aspects, as shown by reference number 720, the network node 110 may transmit, and the UE 120 may receive, beam attribute information. For example, in some aspects, the first communication beam and the second communication beam may be associated with different beam widths and/or different transmission powers. The beam attribute information may be communicated as part of the priority information described in connection with reference number 715, may be communicated in lieu of the priority information described in connection with reference number 715, and/or may be communicated via additional signaling (e.g., control information signaling). For example, receiving the priority information may include receiving information associated with one or more attributes of the first communication beam, the second communication beam, or both.

In some aspects, the UE 120 may receive, and the network node 110 may transmit, one or more attributes corresponding to each communication beam, including a beam width of the first communication beam (e.g., an azimuthal beam width in degrees of the first communication beam), a beam width of the second communication beam (e.g., an azimuthal beam width in degrees of the second communication beam), a relative beam width between the first communication beam and the second communication beam (e.g., a ranking of beams by beam width from large to small and/or from small to large, and/or a qualitative indication of each beam width such as “wide” and/or “narrow”), a beam load of the first communication beam (e.g., a quantitative beam load value of the first communication beam), a beam load of the second communication beam (e.g., a quantitative beam load value of the second communication beam), a relative beam load between the first communication beam and the second communication beam (e.g., a ranking of beams by beam load from large to small and/or from small to large, and/or a qualitative indication of each beam load such as “low load” and/or “high load”), a transmission power associated with the first communication beam (e.g., a quantitative transmission power value of the first communication beam), a transmission power associated with the second communication beam (e.g., a quantitative transmission power value of the second communication beam), and/or a relative transmission power between the first communication beam and the second communication beam (e.g., a ranking of beams by transmission power from large to small and/or from small to large, and/or a qualitative indication of each beam load such as “high”and/or “low”).

As shown by reference number 725, the network node 110 may transmit, and the UE 120 may receive, one or more reference signals via one or more reference signal beams.

As shown by reference number 730, the UE 120 may measure the one or more reference signal beams. For example, the UE 120 may measure a first received power that is associated with the first communication beam and a second received power that is associated with the second communication beam.

As shown by reference number 735, the UE 120 may select a reference signal beam. In some aspects, the UE 120 may select the first communication beam or the second communication beam for transmitting the SDT. For example, the UE 120 may identify a most suitable reference signal beam for communications between the UE 120 and the network node 110 based on the measured channel quality described in connection with reference number 730, the priority information described in connection with reference number 710, and/or the beam attribute information described in connection with reference number 720. For example, the UE 120 may select a communication beam according to the priority information described in connection with reference number 715 in combination with a feature of the UE 120, a feature of the network node 110, or a type of the UE 120.

In some aspects, selecting the communication beam may be according to the priority information and/or in association with the first received power and the second received power described in connection with reference number 730. In some aspects, the priority information described in connection with reference number 715 may include a communication link quality difference threshold. For example, one or more priorities in the priority information may be associated with a delta threshold. In some aspects, the communication link quality difference threshold corresponds to at least one of a feature of the UE, a feature of the network node, or a type of the UE. The delta threshold may indicate a threshold difference in link quality for which a first beam may be prioritized over another beam even if the first beam has a relatively higher priority.

For example, the first communication beam may be associated with a higher priority (e.g., according to the priority information, the attributes of the UE 120, the attributes of the network node 110, attributes of the communication beams, etc.) than a second communication beam. However, the UE 120 may select the first beam when a link quality of the first beam satisfies the delta threshold (e.g., is larger than a link quality of the second beam by at least the delta threshold) and may select the second beam when a link quality of the first beam fails to satisfy the delta threshold (e.g., is smaller than a link quality of the second beam plus the delta threshold), even though the first beam is associated with a higher priority. For example, the UE 120 may select the first communication beam in accordance with a communication link quality of the first communication beam being greater than a communication link quality of the second communication beam by at least a value of the communication link quality difference threshold.

As shown by reference number 740, the UE 120 may transmit, and the network node 110 may receive, a communication beam indication. For example, the UE 120 may transmit an indication of the communication beam selected by the UE 120, as described in connection with reference number 735.

As shown by reference number 745, the network node 110 may transmit, and the UE 120 may receive, a resource allocation. For example, the UE 120 may receive a resource allocation indicating a first set of resources corresponding to the first communication beam and/or a second set of resources corresponding to the second communication beam. In some aspects, the resource allocation may include a configured grant and/or a dynamic grant. In some aspects, the resource allocation may indicate RACH resources for an initial access procedure and/or resources for performing a handover procedure.

As shown by reference number 750, the network node 110 may transmit, and the UE 120 may receive, resource occasion information. For example, the UE 120 may receive an indication of a respective periodicity and/or a respective quantity of resource occasions associated with each of the first set of resources and the second set of resources. The resource occasion information may be communicated as part of the resource allocation described in connection with reference number 745, and/or may be communicated via additional signaling (e.g., additional control information signaling).

In some aspects, the first set of resources may be associated with a first periodicity, and the second set of resources may be associated with a second periodicity different from the first periodicity. Additionally or alternatively, the first set of resources may include a first quantity of resource occasions, and the second set of resources may include a second quantity of resource occasions different from the first quantity of resource occasions.

As shown by reference number 755, the UE 120 may initiate, and the network node 110 may perform, an SDT operation. For example, the UE 120 may transmit and/or receive, and the network node 110 may receive and/or transmit, via the indicated communication beam (e.g., the first communication beam and/or the second communication beam), one or more SDTs in association with selecting a communication beam according to the priority information as described in connection with reference number 735. In some aspects, SDT and/or SDT operation may refer to a set of one or more communications and/or other operations performed while the UE 120 is operating in the inactive mode (e.g., RRC inactive mode). In some aspects, SDT operation and/or SDT may include the communication of one or more relatively small data and/or control information payloads. In some aspects, initiating an SDT operation may include transmitting a first SDT of a set of one or more SDTs, receiving a first SDT of a set of one or more SDTs, and/or preparing (e.g., buffering, loading, decoding) a first SDT of a set of one or more SDTs. In some aspects, performing an SDT operation may include transmitting an SDT of a set of one or more SDTs, receiving an SDT of a set of one or more SDTs, and/or preparing (e.g., buffering, loading, decoding) an SDT of a set of one or more SDTs.

As indicated above, FIG. 7 is provided as an example. Other examples may differ from what is described with respect to FIG. 7.

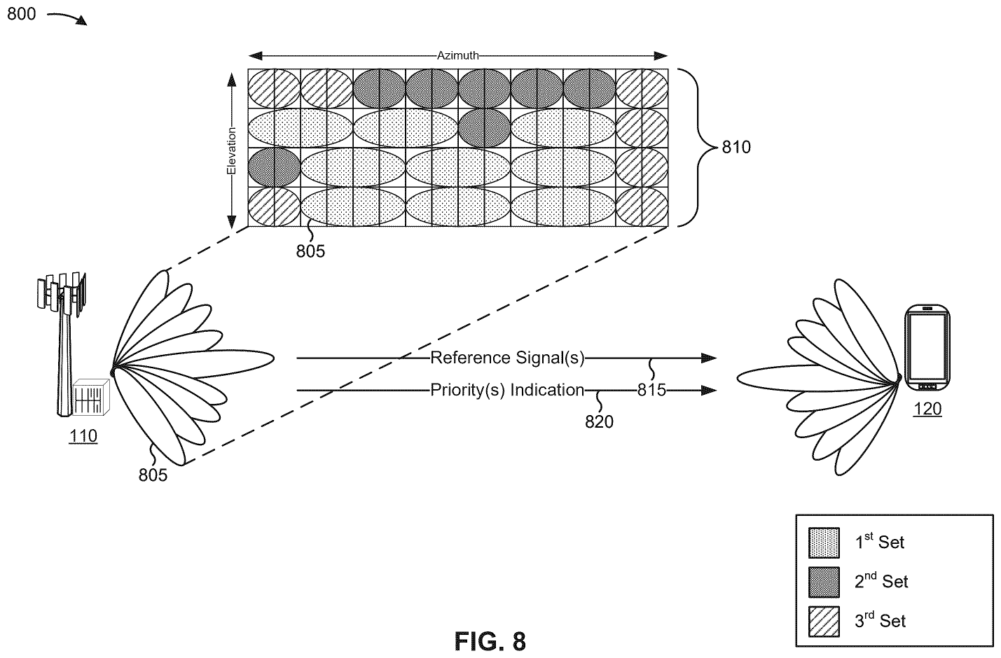

FIG. 8 is a diagram illustrating an example 800 of a wireless communications system that supports NES for SDT-enabled UEs, in accordance with the present disclosure. As shown in FIG. 8, a network node 110 (e.g., one or more network node devices such as an RU, a DU, and/or a CU, among other examples) and a UE 120 may communicate with one another.

The example 800 illustrates the network node 110 and a UE 120 communicating to perform beam management using reference signals (e.g., CSI-RS, SSBs). The example 800 may include aspects of example 300 and/or the first beam management procedure, as described with reference to FIG. 3. The network node 110 may perform beam sweeping over multiple Tx beams 805. The network node 110 may transmit a reference signal using each transmit beam 805.

The network node 110 may configure and/or be configured with a hybrid codebook 810 that represents the different transmit beams 805. For example, as shown by reference number 815, the network node 110 may transmit reference signals via different Tx beams 805 using different beam widths, and/or transmit powers to conserve energy consumed by the operations of the network node 110. In some examples, the Tx beams 805 may span a combined elevational distance of 0 to 30 degrees with respect to the network node 110, such that each Tx beam 805 spans an elevational beam width of 7.5 degrees, and may span a combined azimuthal distance of 0 to 120 degrees with respect to the network node 110. The hybrid codebook 810 may represent beams having different beam widths and/or transmit powers. For example, the hybrid codebook may include a first set of Tx beams having a set of characteristics in common, such as a first beam width and a first transmit power, a second set of Tx beams having a set of characteristics in common, such as a second beam width and a second transmit power, and a third set of Tx beams having a set of characteristics in common, such as the first beam width and a third transmit power. Each Tx beam 805 in the first set of communication beams, the second set of communication beams, and/or the third set of communication beams may be associated with a different beam direction (e.g., may be associated with a unique combination of azimuthal beam width and/or elevation beam width).

The UE 120 may perform beam management with the network node 110 to identify a most appropriate beam for communications between the network node 110 and the UE 120. As used herein, the UE 120 “selecting” and/or “prioritizing” a communication beam refers to the UE 120 identifying, and/or reporting to the network node 110, a most suitable Rx beam corresponding to the Tx beams 805, to enable the network node 110 to select one or more beam pair(s) for communication between the network node 110 and the UE 120. In some aspects, selection of a suitable beam pair may depend on a feature, a combination of features, and/or a type of the UE 120.

In a first scenario, the UE 120 may detect two Tx beams 805 that are associated with a same channel quality (e.g., RSRP). A first Tx beam may be transmitted using a relatively wide beam width (e.g., may be included in the first set of communication beams) and the other Tx beam may be transmitted using a relatively narrow beam width (e.g., may be included in the second set of communication beams and/or the third set of communication beams). In such aspects, the UE 120 may prioritize the Tx beam according to several factors. The UE 120 may be a UE having features according to the second category described with reference to FIG. 1 (e.g., a baseline NR UE), and thus prioritization of the Tx beams transmitted with different beam widths may depend on several factors and/or be decided by network implementation. For example, the wider Tx beam may be associated with a higher priority because the network node 110 may be enabled to refine a wider beam (e.g., transmit the beam using a different width to increase link quality) relatively quickly to higher link gain for the UE 120 in the scenario where link quality with the UE 120 changes. In such examples, reperforming the beam management procedure in response to degrading link quality would consume more resources than refining an existing beam link. Further, the wider Tx beam may be prioritized higher because the UE 120 may be located in the coverage area of the wider Tx beam for a longer duration of time and thus may be less likely to experience beam failure in comparison to the narrower Tx beam (e.g., which may be associated with a smaller coverage area than the wider Tx beam).

Each of the two Tx beams may additionally or alternatively be associated with different loads. For example, if each of the two Tx beams corresponds to a similar quantity of resources (e.g., RACH resources), the less congested Tx beam may be prioritized in some scenarios (e.g., to some network nodes 110 and/or in some networks) because the subsequent access procedure (e.g., RACH procedure, and/or handover procedure) may be less affected by congestion (and thus, less likely to experience link failure and/or degradation). In some other scenarios, the more congested Tx beam may be prioritized in some scenarios (e.g., to some network nodes 110 and/or in some networks) because the network node 110 may be enabled to serve (e.g., communicate with) more UEs using beams having relatively more congestion (e.g., higher load).

In a second scenario, the UE 120 may detect two Tx beams including Tx_X and Tx_Y. Tx_X may be transmitted using a relatively wider beam width and Tx_Y may be transmitted using a relatively narrower beam width. In this scenario, the channel quality (e.g., RSRP) associated with Tx_Y may be slightly greater than the channel quality (e.g., RSRP) associated with Tx_X. In such aspects, the UE 120 may prioritize and/or select a Tx beam 805 according to several factors. The UE 120 may be a UE having features according to the first and/or third categories described with reference to FIG. 1 and may be enabled with SDT. Thus, prioritization of the Tx beams transmitted with different beam widths may depend on several factors and/or be decided by network implementation according to the SDT feature of the UE 120. For example, the network node 110 may perform SDT with the UE 120 using an MCS (e.g., a nominal MCS) corresponding to an SDT channel quality threshold (e.g., SDT_RSRP_Threshold). In such examples, Tx_X and Tx_Y may be associated with equal priorities as long as both channel qualities satisfy the SDT channel quality threshold (e.g., regardless of relative channel quality). However, the network node 110 may be enabled, in some aspects, to adjust the MCS during an SDT session (e.g., if the channel quality of Tx_X and/or Tx_Y changes and/or decreases below the SDT channel quality threshold) according to an error rate pass/fail condition (e.g., if the channel quality of Tx_X and/or Tx_Y fails to satisfy a shared channel CRC pass/fail condition). For example, the network node 110 may adjust the MCS to iteratively assess channel quality during an SDT session in the absence of channel quality measurements (e.g., RSRP measurements). For example, the network node 110 may increase MCS until data and/or control information transmission fails, at which point the network node 110 may adjust the MCS. In such aspects, Tx_Y may have a higher priority because it may be associated with a higher link gain if MCS is adjustable, because a smaller adjustment in MCS may have a bigger impact on throughput for narrower Tx beams. Additionally or alternatively, the network node 110 may be enabled to perform beam refinement during an SDT session (e.g., according to one or more guidelines set by a manufacturer or manager of the network node 110). For example, the network node 110 may transmit PUSCH and/or PUCCH using different Tx beams 805 and may subsequently communicate with the UE 120 during the SDT session using the Tx beam 805 in which the PUSCH and/or PUCCH transmission passed an error rate pass/fail condition (e.g., CRC). In such aspects, the wider beam Tx_X may be prioritized because Tx_X may be associated with more flexibility for identifying a narrower beam (e.g., wider beams may have a greater quantity of subbeams than a narrower beam). Thus, the network node 110 may identify a narrower beam (e.g., a subbeam of Tx_X, SSB_X_1) during an SDT session to achieve a higher MCS. Thus, different Tx beams may be associated with different priorities; however, for the UE 120 to report a most suitable beam according to the priorities, the UE 120 may use additional information to select and/or report a most suitable communication beam as part of the beam selection procedure.

In some aspects, as shown by reference number 820, the network node 110 may transmit, and the UE 120 may receive, an indication of a priority corresponding to each reference signal beam. Additionally or alternatively, the indication of the priorities may include a priority corresponding to each reference signal beam for each feature, combination of features, UE type, and or usage. For example, an SSB beam may be associated with a plurality of priorities which may depend on a combination of the capabilities of the UE 120, the type of communication to be performed using the SSB beam, features of the UE 120, such as RedCap, SDT, and/or Msg3 repetition, and/or a UE type (e.g., any UE type, such as a reduced capability UE, wearable UE, companion UE, mobile device, high priority UE), among other examples. The network node 110 may transmit the priority(ies) indication via broadcast (e.g., via SIB), via control signaling (e.g., via RRC signaling), and/or via signaling associated with a handover procedure (e.g., RACH signaling, four-step random access signaling, two-step random access signaling). In some aspects, the network node 110 may transmit the priority(ies) indication via RRC control signaling if the UE 120 is in the inactive mode and is performing a RACH procedure and/or a handover procedure. For example, the RRC signaling including the priority(ies) indication may be an aspect of the RACH procedure and/or the handover procedure. In some aspects, the network node 110 may dynamically define and/or determine the priorities for each communication beam per combination of features, usage types, etc., and/or may be configured with a set of guidelines for identifying the priorities for each SSB per combination of features, usage types, etc., that would be the same for other network nodes performing such a determination.

In some aspects, one or more priorities of the priority(ies) indication may be associated with a delta threshold. For example, the delta threshold may indicate a threshold difference in link quality for which a first beam may be prioritized over another beam even if the first beam has a relatively higher priority. The UE 120 may receive the priority(ies) indication and may prioritize and/or select for communications, the first beam over the second beam when the second beam's link quality is not better than that of the first beam's link quantity by the delta threshold, regardless of the indicated priorities of the first beam and the second beam. For example, the first beam having an indicated priority higher than an indicated priority of the second beam may be selected if the first beam has a link quality that is higher than a link quality associated with the second beam by at least the delta threshold. In such respects, the indicated priorities may thus be conditional upon the delta threshold. In some aspects, the delta threshold may be defined and/or configured differently for each communication beam according to the combination of features, usage types, etc. Thus, each communication beam may be associated with multiple priorities depending on characteristics of the UE 120, each priority may be associated with a respective delta threshold, and/or each communication beam may be associated with multiple delta thresholds depending on characteristics of the UE 120.

Additionally or alternatively to the priority(ies) indication, the network node 110 may transmit, and the UE 120 may receive, information for each communication beam. For example, the network node 110 may indicate, to the UE 120, one or more parameters associated with each communication beam, such as a beam width, a beam load (e.g., a measure and/or indication of resources of the communication beam being used by other UEs communicating with the network node 110), or a transmit power, among other example measurements relevant to whether a communication beam will be suitable for communications between the network node 110 and the UE 120. In some aspects, the one or more parameters may indicate a relative beam width for each indicated communication beam, a relative load for each indicated beam width, a relative transmit power, and/or any other relative measurements related to whether the UE 120 will effectively communicate using the communication beam. The term “relative,” in these aspects, may refer to a ranking of beams according to the parameter rather than an explicit measurement of the beam parameter, and/or may refer to a qualitative indication of the beam parameters, such as wide and/or narrow, high and/or low, large and/or small, among other examples. In such aspects, qualitative indications may be universally defined for each wireless communications device operating within a network and/or may be associated with a predefined quantity threshold (e.g., parameters measuring below the threshold may be associated with a first quality, and/or parameters measuring above the threshold may be associated with a second quality. Additionally or alternatively, qualitative indications may be dependent on one or more aspects of the UE 120.

As a result, the UE 120 may receive the indication of the beam attributes (e.g., in place of the priority(ies) indication shown by reference number 820, as part of the priority(ies) indication shown by reference number 820, and/or in signaling in addition to the priority(ies) indication signaling shown by reference number 820), and may prioritize and/or select a communication beam based on a set of rules and/or guidelines for determining beam priority. In some other aspects, the UE 120 may receive the beam attributes in addition to the priority(ies) indication and may take the beam attributes into account when identifying a beam priority and/or selecting a beam. For example, each beam may be associated with a priority for each combination of features and for each combination of beam attributes.

In some aspects, the network node 110 may perform load balancing between different reference signal beams. For example, the network node 110 may distribute a total communication load among different reference signal beams (e.g., that are transmitted with different beam widths and/or transmit powers) by configuring different resources for each SSB. For example, UEs in communication with a same network node may select different communication beams based on a respective location of the UE 120 and thus may communicate using different resources (e.g., configured grant resources and/or initial access resources) according to the load balancing configuration implemented by the network node 110.

In some examples, the network node 110 may configure a first set of resources for communications via a first communication beam and may configure a different set of resources for communications via a different communication beam. For example, the network node 110 may configure a corresponding set of resources (e.g., CG-SDT-PUSCH resources) for each reference signal beam (e.g., SSB beam, CSI-RS beam) of a set of one or more reference signal beams. In some aspects, each corresponding set of resources may be associated with a periodicity of resource occasions that is different from the periodicity of resource occasions associated with other sets of resources. For example, different sets of resources may be configured with different (e.g., unique relative to periodicities associated with other configured sets of resources for the set of reference signal beams) periodicities.

In some aspects, each corresponding set of resources may be associated with a quantity of resource occasions that is different from the quantity of resource occasions associated with other sets of resources. For example, different sets of resources may be configured with different quantities of resource occasions (e.g., unique relative to quantities associated with other configured sets of resources for the set of reference signal beams).

In such aspects, the network node 110 may transmit, and the UE 120 may receive, an indication of the periodicity and/or the quantity of resource occasions for each reference signal beam.

As indicated above, FIG. 8 is provided as an example. Other examples may differ from what is described with respect to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with beam selection for SDT.

As shown in FIG. 9, in some aspects, process 900 may include receiving, from a network node, priority information associated with a first communication beam and a second communication beam (block 910). For example, the UE (e.g., using reception component 1102 and/or communication manager 1106, depicted in FIG. 11) may receive, from a network node, priority information associated with a first communication beam and a second communication beam, as described above.

As further shown in FIG. 9, in some aspects, process 900 may include initiating, with the network node via at least one of the first communication beam or the second communication beam, an SDT operation in association with selecting a communication beam according to the priority information (block 920). For example, the UE (e.g., using transmission component 1104 and/or communication manager 1106, depicted in FIG. 11) may initiate, with the network node using at least one of the first communication beam or the second communication beam, an SDT operation in association with selecting a communication beam according to the priority information, as described above.

Process 900 may include additional aspects, such as any single aspect or any combination of aspects described below and/or in connection with one or more other processes described elsewhere herein.

In a first aspect, process 900 includes selecting at least one of the first communication beam or the second communication beam for initiating the SDT operation.

In a second aspect, alone or in combination with the first aspect, selecting the communication beam according to the priority information is associated with at least one of a feature of the UE, a feature of the network node, or a type of the UE.

In a third aspect, alone or in combination with one or more of the first and second aspects, receiving the priority information comprises receiving information associated with one or more attributes of the first communication beam, or the second communication beam, or both.

In a fourth aspect, alone or in combination with one or more of the first through third aspects, the one or more attributes comprise at least one of a beam width of the first communication beam, a beam width of the second communication beam, a relative beam width between the first communication beam and the second communication beam, a beam load of the first communication beam, a beam load of the second communication beam, a relative beam load between the first communication beam and the second communication beam, a transmission power associated with the first communication beam, a transmission power associated with the second communication beam, or a relative transmission power between the first communication beam and the second communication beam.

In a fifth aspect, alone or in combination with one or more of the first through fourth aspects, receiving the priority information comprises receiving an SIB including the priority information.

In a sixth aspect, alone or in combination with one or more of the first through fifth aspects, receiving the priority information comprises receiving, while operating in at least one of an RRC inactive mode or a handover mode, RRC signaling including the priority information.

In a seventh aspect, alone or in combination with one or more of the first through sixth aspects, the priority information corresponds to at least one of a feature of the UE, a feature of the network node, or a type of the UE.

In an eighth aspect, alone or in combination with one or more of the first through seventh aspects, the first communication beam comprises at least one of a first SSB beam or a first CSI-RS beam, and the second communication beam comprises at least one of a second SSB beam or a second CSI-RS beam.

In a ninth aspect, alone or in combination with one or more of the first through eighth aspects, the priority information includes a communication link quality difference threshold.

In a tenth aspect, alone or in combination with one or more of the first through ninth aspects, process 900 includes selecting the first communication beam in accordance with a communication link quality of the first communication beam being greater than a communication link quality of the second communication beam by at least a value of the communication link quality difference threshold.

In an eleventh aspect, alone or in combination with one or more of the first through tenth aspects, the communication link quality difference threshold corresponds to at least one of a feature of the UE, a feature of the network node, or a type of the UE.

In a twelfth aspect, alone or in combination with one or more of the first through eleventh aspects, the priority information includes at least one of a first abstract priority that is associated with the first communication beam and a second abstract priority that is associated with the second communication beam.

In a thirteenth aspect, alone or in combination with one or more of the first through twelfth aspects, process 900 includes receiving a resource allocation indicating a first set of resources corresponding to the first communication beam and a second set of resources corresponding to the second communication beam.

In a fourteenth aspect, alone or in combination with one or more of the first through thirteenth aspects, process 900 includes receiving an indication of at least one of a respective periodicity or a respective quantity of resource occasions associated with each of the first set of resources and the second set of resources.

In a fifteenth aspect, alone or in combination with one or more of the first through fourteenth aspects, the resource allocation indicates random access channel resources for initial access.

In a sixteenth aspect, alone or in combination with one or more of the first through fifteenth aspects, the resource allocation comprises a configured grant.

In a seventeenth aspect, alone or in combination with one or more of the first through sixteenth aspects, the first set of resources is associated with a first periodicity, and the second set of resources is associated with a second periodicity different from the first periodicity.

In an eighteenth aspect, alone or in combination with one or more of the first through seventeenth aspects, the first set of resources includes a first quantity of resource occasions, and the second set of resources includes a second quantity of resource occasions different from the first quantity of resource occasions.

In a nineteenth aspect, alone or in combination with one or more of the first through eighteenth aspects, the first communication beam and the second communication beam are associated with at least one of different beam widths or different transmission powers.

In a twentieth aspect, alone or in combination with one or more of the first through nineteenth aspects, process 900 includes measuring a first received power that is associated with the first communication beam and a second received power that is associated with the second communication beam, and selecting the first communication beam or the second communication beam, according to the priority information and in association with the first received power and the second received power.

In a twenty-first aspect, alone or in combination with one or more of the first through twentieth aspects, process 900 includes transmitting, to the network node, an indication of the communication beam selected by the UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with beam selection for SDT.

As shown in FIG. 10, in some aspects, process 1000 may include transmitting, to a UE, priority information associated with a first communication beam and a second communication beam (block 1010). For example, the network node (e.g., using transmission component 1204 and/or communication manager 1206, depicted in FIG. 12) may transmit, to a UE, priority information associated with a first communication beam and a second communication beam, as described above.

As further shown in FIG. 10, in some aspects, process 1000 may include performing, via a communication beam that is selected by the UE, an SDT operation according to the priority information, wherein the communication beam includes at least one of the first communication beam or the second communication beam (block 1020). For example, the network node (e.g., using reception component 1202 and/or communication manager 1206, depicted in FIG. 12) may perform via a communication beam that is selected by the UE, an SDT operation according to the priority information, wherein the communication beam includes at least one of the first communication beam or the second communication beam, as described above.

Process 1000 may include additional aspects, such as any single aspect or any combination of aspects described below and/or in connection with one or more other processes described elsewhere herein.

In a first aspect, performing the SDT operation according to the priority information is associated with at least one of a feature of the UE, a feature of the network node, or a type of the UE.

In a second aspect, alone or in combination with the first aspect, transmitting the priority information comprises transmitting information associated with one or more attributes of the first communication beam, or the second communication beam, or both.

In a third aspect, alone or in combination with one or more of the first and second aspects, the one or more attributes comprise at least one of a beam width of the first communication beam, a beam width of the second communication beam, a relative beam width between the first communication beam and the second communication beam, a beam load of the first communication beam, a beam load of the second communication beam, a relative beam load between the first communication beam and the second communication beam, a transmission power associated with the first communication beam, a transmission power associated with the second communication beam, or a relative transmission power between the first communication beam and the second communication beam.

In a fourth aspect, alone or in combination with one or more of the first through third aspects, transmitting the priority information comprises transmitting an SIB including the priority information.

In a fifth aspect, alone or in combination with one or more of the first through fourth aspects, transmitting the priority information comprises transmitting RRC signaling including the priority information.

In a sixth aspect, alone or in combination with one or more of the first through fifth aspects, the priority information corresponds to at least one of a feature of the UE, a feature of the network node, or a type of the UE.

In a seventh aspect, alone or in combination with one or more of the first through sixth aspects, the first communication beam comprises at least one of a first SSB beam or a first CSI-RS beam, and the second communication beam comprises at least one of a second SSB beam or a second CSI-RS beam.

In an eighth aspect, alone or in combination with one or more of the first through seventh aspects, the priority information includes a communication link quality difference threshold.

In a ninth aspect, alone or in combination with one or more of the first through eighth aspects, the communication link quality difference threshold corresponds to at least one of a feature of the UE, a feature of the network node, or a type of the UE.

In a tenth aspect, alone or in combination with one or more of the first through ninth aspects, the priority information includes at least one of a first abstract priority that is associated with the first communication beam and a second abstract priority that is associated with the second communication beam.

In an eleventh aspect, alone or in combination with one or more of the first through tenth aspects, process 1000 includes transmitting a resource allocation indicating a first set of resources corresponding to the first communication beam and a second set of resources corresponding to the second communication beam.

In a twelfth aspect, alone or in combination with one or more of the first through eleventh aspects, process 1000 includes transmitting an indication of at least one of a respective periodicity or a respective quantity of resource occasions associated with each of the first set of resources and the second set of resources.

In a thirteenth aspect, alone or in combination with one or more of the first through twelfth aspects, the resource allocation indicates random access channel resources for initial access.

In a fourteenth aspect, alone or in combination with one or more of the first through thirteenth aspects, the resource allocation comprises a configured grant.

In a fifteenth aspect, alone or in combination with one or more of the first through fourteenth aspects, the first set of resources is associated with a first periodicity, and the second set of resources is associated with a second periodicity different from the first periodicity.

In a sixteenth aspect, alone or in combination with one or more of the first through fifteenth aspects, the first set of resources includes a first quantity of resource occasions, and the second set of resources includes a second quantity of resource occasions different from the first quantity of resource occasions.

In a seventeenth aspect, alone or in combination with one or more of the first through sixteenth aspects, the first communication beam and the second communication beam are associated with at least one of different beam widths or different transmission powers.

In an eighteenth aspect, alone or in combination with one or more of the first through seventeenth aspects, process 1000 includes receiving an indication of the communication beam that is selected by the UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 7-8. Additionally, or alternatively, the apparatus 1100 may be configured to perform one or more processes described herein, such as process 9 of FIG. 9, or a combination thereof. In some aspects, the apparatus 1100 and/or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, from a network node, priority information associated with a first communication beam and a second communication beam. The communication manager 1106 and/or the transmission component 1104 may initiate, with the network node via at least one of the first communication beam or the second communication beam, an SDT operation in association with selecting a communication beam according to the priority information.

The communication manager 1106 may select at least one of the first communication beam or the second communication beam for initiating the SDT operation. The reception component 1102 may receive information associated with one or more attributes of the first communication beam, or the second communication beam, or both. The reception component 1102 may receive an SIB including the priority information. The reception component 1102 may receive, while operating in at least one of an RRC inactive mode or a handover mode, RRC signaling including the priority information.

The communication manager 1106 may select the first communication beam in accordance with a communication link quality of the first communication beam being greater than a communication link quality of the second communication beam by at least a value of the communication link quality difference threshold.

The reception component 1102 may receive a resource allocation indicating a first set of resources corresponding to the first communication beam and a second set of resources corresponding to the second communication beam. The reception component 1102 may receive an indication of at least one of a respective periodicity or a respective quantity of resource occasions associated with each of the first set of resources and the second set of resources.

The communication manager 1106 may measure a first received power that is associated with the first communication beam and a second received power that is associated with the second communication beam. The communication manager 1106 may select the first communication beam or the second communication beam, according to the priority information and in association with the first received power and the second received power. The transmission component 1104 may transmit, to the network node, an indication of the communication beam selected by the UE.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 7-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 1. Additionally, or alternatively, one or more components shown in FIG. 12 may be implemented within one or more components described in connection with FIG. 1.

Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a UE, priority information associated with a first communication beam and a second communication beam. The communication manager 1206 and/or the reception component 1202 may perform, via a communication beam that is selected by the UE, an SDT operation according to the priority information, wherein the communication beam includes at least one of the first communication beam or the second communication beam.

The transmission component 1204 may transmit information associated with one or more attributes of the first communication beam, or the second communication beam, or both. The transmission component 1204 may transmit an SIB including the priority information. The transmission component 1204 may transmit RRC signaling including the priority information. The transmission component 1204 may transmit a resource allocation indicating a first set of resources corresponding to the first communication beam and a second set of resources corresponding to the second communication beam.

The transmission component 1204 may transmit an indication of at least one of a respective periodicity or a respective quantity of resource occasions associated with each of the first set of resources and the second set of resources. The reception component 1202 may receive an indication of the communication beam that is selected by the UE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: receiving, from a network node, priority information associated with a first communication beam and a second communication beam; and initiating, with the network node via at least one of the first communication beam or the second communication beam, a small data transmission operation in association with selecting a communication beam according to the priority information.
Aspect 2: The method of Aspect 1, further comprising: selecting at least one of the first communication beam or the second communication beam for initiating the small data transmission operation.
Aspect 3: The method of any of Aspects 1-2, wherein selecting the communication beam according to the priority information is associated with at least one of a feature of the UE, a feature of the network node, or a type of the UE.
Aspect 4: The method of any of Aspects 1-3, wherein receiving the priority information comprises: receiving information associated with one or more attributes of the first communication beam, or the second communication beam, or both.
Aspect 5: The method of Aspect 4, wherein the one or more attributes comprise at least one of: a beam width of the first communication beam, a beam width of the second communication beam, a relative beam width between the first communication beam and the second communication beam, a beam load of the first communication beam, a beam load of the second communication beam, a relative beam load between the first communication beam and the second communication beam, a transmission power associated with the first communication beam, a transmission power associated with the second communication beam, or a relative transmission power between the first communication beam and the second communication beam.
Aspect 6: The method of any of Aspects 1-5, wherein receiving the priority information comprises: receiving a system information block including the priority information.
Aspect 7: The method of any of Aspects 1-6, wherein receiving the priority information comprises: receiving, while operating in at least one of a radio resource control inactive mode or a handover mode, radio resource control signaling including the priority information.
Aspect 8: The method of any of Aspects 1-7, wherein the priority information corresponds to at least one of a feature of the UE, a feature of the network node, or a type of the UE.
Aspect 9: The method of any of Aspects 1-8, wherein the first communication beam comprises at least one of a first SSB beam or a first CSI-RS beam, and the second communication beam comprises at least one of a second SSB beam or a second CSI-RS beam.
Aspect 10: The method of any of Aspects 1-9, wherein the priority information includes a communication link quality difference threshold.
Aspect 11: The method of Aspect 10, further comprising: selecting the first communication beam in accordance with a communication link quality of the first communication beam being greater than a communication link quality of the second communication beam by at least a value of the communication link quality difference threshold.
Aspect 12: The method of any of Aspects 10-11, wherein the communication link quality difference threshold corresponds to at least one of a feature of the UE, a feature of the network node, or a type of the UE.
Aspect 13: The method of any of Aspects 1-12, wherein the priority information includes at least one of a first abstract priority that is associated with the first communication beam and a second abstract priority that is associated with the second communication beam.
Aspect 14: The method of any of Aspects 1-13, further comprising: receiving a resource allocation indicating a first set of resources corresponding to the first communication beam and a second set of resources corresponding to the second communication beam.
Aspect 15: The method of Aspect 14, further comprising: receiving an indication of at least one of a respective periodicity or a respective quantity of resource occasions associated with each of the first set of resources and the second set of resources.
Aspect 16: The method of any of Aspects 14-15, wherein the resource allocation indicates random access channel resources for initial access.
Aspect 17: The method of any of Aspects 14-15, wherein the resource allocation comprises a configured grant.
Aspect 18: The method of any of Aspects 14-17, wherein the first set of resources is associated with a first periodicity, and the second set of resources is associated with a second periodicity different from the first periodicity.
Aspect 19: The method of any of Aspects 14-18, wherein the first set of resources includes a first quantity of resource occasions, and the second set of resources includes a second quantity of resource occasions different from the first quantity of resource occasions.
Aspect 20: The method of any of Aspects 1-19, wherein the first communication beam and the second communication beam are associated with at least one of different beam widths or different transmission powers.
Aspect 21: The method of any of Aspects 1-20, further comprising: measuring a first received power that is associated with the first communication beam and a second received power that is associated with the second communication beam; and selecting the first communication beam or the second communication beam, according to the priority information and in association with the first received power and the second received power.
Aspect 22: The method of any of Aspects 1-21, further comprising: transmitting, to the network node, an indication of the communication beam selected by the UE.
Aspect 23: A method of wireless communication performed by a network node, comprising: transmitting, to a user equipment (UE), priority information associated with a first communication beam and a second communication beam; and performing, via a communication beam that is selected by the UE, a small data transmission operation according to the priority information, wherein the communication beam includes at least one of the first communication beam or the second communication beam.
Aspect 24: The method of Aspect 23, wherein performing the small data transmission operation according to the priority information is associated with at least one of a feature of the UE, a feature of the network node, or a type of the UE.
Aspect 25: The method of any of Aspects 23-24, wherein transmitting the priority information comprises: transmitting information associated with one or more attributes of the first communication beam, or the second communication beam, or both.
Aspect 26: The method of Aspect 25, wherein the one or more attributes comprise at least one of: a beam width of the first communication beam, a beam width of the second communication beam, a relative beam width between the first communication beam and the second communication beam, a beam load of the first communication beam, a beam load of the second communication beam, a relative beam load between the first communication beam and the second communication beam, a transmission power associated with the first communication beam, a transmission power associated with the second communication beam, or a relative transmission power between the first communication beam and the second communication beam.
Aspect 27: The method of any of Aspects 23-26, wherein transmitting the priority information comprises: transmitting a system information block including the priority information.
Aspect 28: The method of any of Aspects 23-27, wherein transmitting the priority information comprises: transmitting radio resource control signaling including the priority information.
Aspect 29: The method of any of Aspects 23-28, wherein the priority information corresponds to at least one of a feature of the UE, a feature of the network node, or a type of the UE.
Aspect 30: The method of any of Aspects 23-29, wherein the first communication beam comprises at least one of a first SSB beam or a first CSI-RS beam, and the second communication beam comprises at least one of a second SSB beam or a second CSI-RS beam.
Aspect 31: The method of any of Aspects 23-30, wherein the priority information includes a communication link quality difference threshold.
Aspect 32: The method of Aspect 31, wherein the communication link quality difference threshold corresponds to at least one of a feature of the UE, a feature of the network node, or a type of the UE.
Aspect 33: The method of any of Aspects 23-32, wherein the priority information includes at least one of a first abstract priority that is associated with the first communication beam and a second abstract priority that is associated with the second communication beam.
Aspect 34: The method of any of Aspects 23-33, further comprising: transmitting a resource allocation indicating a first set of resources corresponding to the first communication beam and a second set of resources corresponding to the second communication beam.
Aspect 35: The method of Aspect 34, further comprising: transmitting an indication of at least one of a respective periodicity or a respective quantity of resource occasions associated with each of the first set of resources and the second set of resources.
Aspect 36: The method of any of Aspects 34-35, wherein the resource allocation indicates random access channel resources for initial access.
Aspect 37: The method of any of Aspects 34-35, wherein the resource allocation comprises a configured grant.
Aspect 38: The method of any of Aspects 34-37, wherein the first set of resources is associated with a first periodicity, and the second set of resources is associated with a second periodicity different from the first periodicity.
Aspect 39: The method of any of Aspects 34-38, wherein the first set of resources includes a first quantity of resource occasions, and the second set of resources includes a second quantity of resource occasions different from the first quantity of resource occasions.
Aspect 40: The method of any of Aspects 23-39, wherein the first communication beam and the second communication beam are associated with at least one of different beam widths or different transmission powers.
Aspect 41: The method of any of Aspects 23-40, further comprising: receiving an indication of the communication beam that is selected by the UE.
Aspect 42: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-41.
Aspect 43: An apparatus for wireless communication at a device, the apparatus comprising one or more memories and one or more processors coupled to the one or more memories, the one or more processors individually or collectively configured to cause the device to perform the method of one or more of Aspects 1-41.
Aspect 44: An apparatus for wireless communication, the apparatus comprising at least one means for performing the method of one or more of Aspects 1-41.
Aspect 45: A non-transitory computer-readable medium storing code for wireless communication, the code comprising instructions executable by one or more processors to perform the method of one or more of Aspects 1-41.
Aspect 46: A non-transitory computer-readable medium storing a set of instructions for wireless communication, the set of instructions comprising one or more instructions that, when executed by one or more processors of a device, cause the device to perform the method of one or more of Aspects 1-41.
Aspect 47: A device for wireless communication, the device comprising a processing system that includes one or more processors and one or more memories coupled with the one or more processors, the processing system individually or collectively configured to cause the device to perform the method of one or more of Aspects 1-41.
Aspect 48: An apparatus for wireless communication at a device, the apparatus comprising one or more memories and one or more processors coupled to the one or more memories, the one or more processors individually or collectively configured to cause the device to perform the method of one or more of Aspects 1-41.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a +b+c, as well as any combination with multiples of the same element (for example, a +a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, individually or collectively configured to cause the UE to:
receive, from a network node, priority information associated with a first communication beam and a second communication beam; and
initiate, with the network node using at least one of the first communication beam or the second communication beam, a small data transmission operation in association with selecting a communication beam according to the priority information.

2. The apparatus of claim 1, wherein the one or more processors are further configured to cause the UE to:
select at least one of the first communication beam or the second communication beam for initiating the small data transmission operation.

3. The apparatus of claim 1, wherein selecting the communication beam according to the priority information is associated with at least one of a feature of the UE, a feature of the network node, or a type of the UE.

4. The apparatus of claim 1, wherein the one or more processors, to cause the UE to receive the priority information, are configured to cause the UE to:
receive information associated with one or more attributes of the first communication beam, or the second communication beam, or both.

5. The apparatus of claim 4, wherein the one or more attributes comprise at least one of:
a beam width of the first communication beam,
a beam width of the second communication beam,
a relative beam width between the first communication beam and the second communication beam,
a beam load of the first communication beam,
a beam load of the second communication beam,
a relative beam load between the first communication beam and the second communication beam,
a transmission power associated with the first communication beam,
a transmission power associated with the second communication beam, or
a relative transmission power between the first communication beam and the second communication beam.

6. The apparatus of claim 1, wherein the priority information corresponds to at least one of a feature of the UE, a feature of the network node, or a type of the UE.

7. The apparatus of claim 1, wherein the first communication beam comprises at least one of a first SSB beam or a first CSI-RS beam, and the second communication beam comprises at least one of a second SSB beam or a second CSI-RS beam.

8. An apparatus for wireless communication at a network node, comprising:
one or more memories; and
one or more processors, coupled to the one or more memories, individually or collectively configured to cause the network node to:
transmit, to a user equipment (UE), priority information associated with a first communication beam and a second communication beam; and
perform, via a communication beam that is selected by the UE, a small data transmission operation according to the priority information, wherein the communication beam includes at least one of the first communication beam or the second communication beam.

9. The apparatus of claim 8, wherein performing the small data transmission operation according to the priority information is associated with at least one of a feature of the UE, a feature of the network node, or a type of the UE.

10. The apparatus of claim 8, wherein the one or more processors, to cause the network node to transmit the priority information, are configured to cause the network node to:
transmit information associated with one or more attributes of the first communication beam, or the second communication beam, or both.

11. The apparatus of claim 10, wherein the one or more attributes comprise at least one of:
a beam width of the first communication beam,
a beam width of the second communication beam,
a relative beam width between the first communication beam and the second communication beam,
a beam load of the first communication beam,
a beam load of the second communication beam,
a relative beam load between the first communication beam and the second communication beam,
a transmission power associated with the first communication beam,
a transmission power associated with the second communication beam, or
a relative transmission power between the first communication beam and the second communication beam.

12. The apparatus of claim 8, wherein the priority information corresponds to at least one of a feature of the UE, a feature of the network node, or a type of the UE.

13. The apparatus of claim 8, wherein the first communication beam comprises at least one of a first SSB beam or a first CSI-RS beam, and the second communication beam comprises at least one of a second SSB beam or a second CSI-RS beam.

14. A method of wireless communication performed by a user equipment (UE), comprising:
receiving, from a network node, priority information associated with a first communication beam and a second communication beam; and
initiating, with the network node using at least one of the first communication beam or the second communication beam, a small data transmission operation in association with selecting a communication beam according to the priority information.

15. The method of claim 14, wherein the priority information includes a communication link quality difference threshold.

16. The method of claim 15, further comprising:
selecting the first communication beam in accordance with a communication link quality of the first communication beam being greater than a communication link quality of the second communication beam by at least a value of the communication link quality difference threshold.

17. The method of claim 15, wherein the communication link quality difference threshold corresponds to at least one of a feature of the UE, a feature of the network node, or a type of the UE.

18. The method of claim 14, wherein the priority information includes at least one of a first abstract priority that is associated with the first communication beam and a second abstract priority that is associated with the second communication beam.

19. The method of claim 14, further comprising:
receiving a resource allocation indicating a first set of resources corresponding to the first communication beam and a second set of resources corresponding to the second communication beam.

20. The method of claim 19, further comprising:
receiving an indication of at least one of a respective periodicity or a respective quantity of resource occasions associated with each of the first set of resources and the second set of resources.

21. The method of claim 19, wherein the resource allocation comprises a configured grant.

22. The method of claim 14, wherein the first communication beam and the second communication beam are associated with at least one of different beam widths or different transmission powers.

23. The method of claim 14, further comprising:
measuring a first received power that is associated with the first communication beam and a second received power that is associated with the second communication beam; and
selecting the first communication beam or the second communication beam, according to the priority information and in association with the first received power and the second received power.

24. A method of wireless communication performed by a network node, comprising:
transmitting, to a user equipment (UE), priority information associated with a first communication beam and a second communication beam; and
performing, via a communication beam that is selected by the UE, a small data transmission operation according to the priority information, wherein the communication beam includes at least one of the first communication beam or the second communication beam.

25. The method of claim 24, wherein the priority information includes a communication link quality difference threshold.

26. The method of claim 25, wherein the communication link quality difference threshold corresponds to at least one of a feature of the UE, a feature of the network node, or a type of the UE.

27. The method of claim 24, wherein the priority information includes at least one of a first abstract priority that is associated with the first communication beam and a second abstract priority that is associated with the second communication beam.

28. The method of claim 24, further comprising:
transmitting a resource allocation indicating a first set of resources corresponding to the first communication beam and a second set of resources corresponding to the second communication beam.

29. The method of claim 28, further comprising:
transmitting an indication of at least one of a respective periodicity or a respective quantity of resource occasions associated with each of the first set of resources and the second set of resources.

30. The method of claim 24, wherein the first communication beam and the second communication beam are associated with at least one of different beam widths or different transmission powers.
